(19) United States
(12) Patent Application Publication
(10) Pub. No.: US 2008/0080921 A1
(43) Pub. Date: Apr. 3, 2008

(54) PRINTER AND METHOD OF INTERRUPTING PRINT PROCESS AT TIME OF DETECTING MISMATCH IN PAPER SIZE IN CONTINUOUS TRANSPORT MODE

(75) Inventors: Takuya YASUE, Matsinoto-shi (JP); Jun FUKASAWA, Nagano-Ken (JP)

Correspondence Address: SUGHRUE-265550, 2100 PENNSYLVANIA AVE. NW, WASHINGTON, DC, 20037-3213, US

(73) Assignee: SEIKO EPSON CORPORATION, Suwa-shi (JP)

(21) Appl. No.: 11/863,389

(22) Filed: Sep. 28, 2007

(30) Foreign Application Priority Data
Sep. 29, 2006 (JP) 2006-267607

(51) Int. Cl. B41J 11/50

(52) U.S. Cl. 400/605

(57) ABSTRACT

A method of interrupting a print process in a continuous transport mode, in which a first roller and a second roller that is disposed at a downstream side of the first roller transport, a plurality of printing mediums including a first medium and a second medium immediately subsequent to the first medium, to a printing area at which a printing operation corresponding to print data is performed to the printing mediums, and a third roller is operable to transport the printing mediums together with the first roller with being in contact with the first roller, includes: detecting the printing mediums, respectively, between the first roller and the second roller; driving the first roller and the second roller until a leading end edge of the second medium is detected, when a size of the first medium is different from a size specified by the print data; separating the third roller from the first roller; and driving only the second roller to transport the second medium after the third roller is separated from the first roller.

### BACKGROUND

1. Technical Field

The present invention relates to a printer and a method of interrupting a print process at the time of detecting a mismatch in paper size in a continuous transport mode.

2. Related Art

Printers having an LD (Load) roller for supplying a printing medium into the printers and a PF (Paper Feed) roller for transporting the printing medium supplied into the printers are known as ink jet printers for performing a printing operation on a printing medium such as a sheet of regular paper (for example, see JP-A-2002-284373 and JP-A-2002-284374).

Specifically, in the printer described in JP-A-2002-284373 or JP-A-2002-284374, it is possible to continuously feed plural printing sheets by the use of the LD roller with a hopper kept in a raised state. When the plural printing sheets are continuously fed, a feed gap of the printing mediums is shortened, thereby enhancing the number of printing sheets which can be subjected to the printing operation per unit time.

In the printer described in JP-A-2002-24373 or JP-A-2002-284374, the hopper is maintained in the raised state. In this state, by continuously feeding the plural printing mediums on the feed tray to the printing area, it is possible to enhance the number of printing mediums that can be fed per unit time, in comparison with the case where the plural printing mediums on the feed tray are individually transported.

However, when a mismatch in paper size is detected in a process of continuously feeding the plural printing mediums, the printer cannot stop the print process at the time of detecting the mismatch. At the time of interrupting the print process in the related printer in which the printing mediums are individually transported and subjected to a printing operation, the printing medium can be discharged by a discharge process of a print control thereof and the print process can be stopped. However, in the printer in which the plural printing mediums are continuously fed, a subsequent printing medium is fed in the discharge process. That is, even when the print operation is stopped in the discharge process under a continuous print process, a state where no printing medium remains in a printing medium transport path cannot be obtained. Accordingly, in the printer in which the plural printing mediums are continuously fed, even when the mismatch in paper size is detected during the printing operation on the first printing medium, it is necessary to wait until all the expected number of printing mediums are discharged. Therefore, the print process cannot be properly interrupted.

### SUMMARY

An advantage of some aspects of the invention is to provide a printer which can interrupt a print process at the time of detecting a mismatch in paper size in the course of continuously transporting a plurality of printing mediums and a method of interrupting a print process at the time of detecting a mismatch in paper size in a continuous transport mode.

According to an aspect of the invention, there is provided a method of interrupting a print process in a continuous transport mode, in which a first roller and a second roller that is disposed at a downstream side of the first roller are operable to transport, a plurality of printing mediums including a first medium and a second medium immediately subsequent to the first medium, to a printing area at which a printing operation corresponding to print data is performed to the plurality of printing medium, and a third roller is operable to transport the plurality of printing mediums together with the first roller with being in contact with the first roller, the method comprising:

detecting the plurality of printing mediums, respectively, between the first roller and the second roller;

driving the first roller and the second roller until a leading end edge of the second medium is detected, when a size of the first medium is different from a size specified by the print data:

separating the third roller from the first roller; and

driving only the second roller to transport the second medium after the third roller is separated from the first roller.

The present disclosure relates to the subject matter contained in Japanese patent application No. 2006-267607 filed on Sep. 29, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a side view of an ink jet printer according to an embodiment of the invention.

FIG. 2 is a block diagram illustrating a control system of the ink jet printer shown in FIG. 1.

FIG. 3 is a diagram illustrating a data structure of continuous-printing print data in the embodiment.

FIG. 4 is a flowchart illustrating a main flow of processes that are performed by the ink jet printer shown in FIG. 1.

FIG. 5 is a flowchart illustrating a flow of a feed process that is performed by the ink jet printer shown in FIG. 1.

FIG. 6 is a flowchart illustrating a main flow of a paper feeding process that is performed by the ink jet printer shown in FIG. 1.

FIG. 7 is a flowchart illustrating a sub flow of the paper feeding process that is performed by the ink jet printer shown in FIG. 1.

FIG. 8 is a flowchart illustrating a flow of a discharge process that is performed by the ink jet printer shown in FIG. 1.

FIG. 9 is a diagram illustrating a feature comparison table of a synchronization (tracing) control and a simultaneous driving control.

### DESCRIPTION OF EXEMPLARY EMBODIMENTS

Hereinafter, a printer and a method of interrupting a print process at the time of detecting a mismatch in paper size in a continuous transport mode according to an exemplary embodiment of the invention will be described with reference to the accompanying drawings. An ink jet printer is described as an example of the printer. The method of interrupting a print process at the time of detecting a mismatch in paper size in a continuous transport mode is described as a part of arm operation of the ink jet printer.

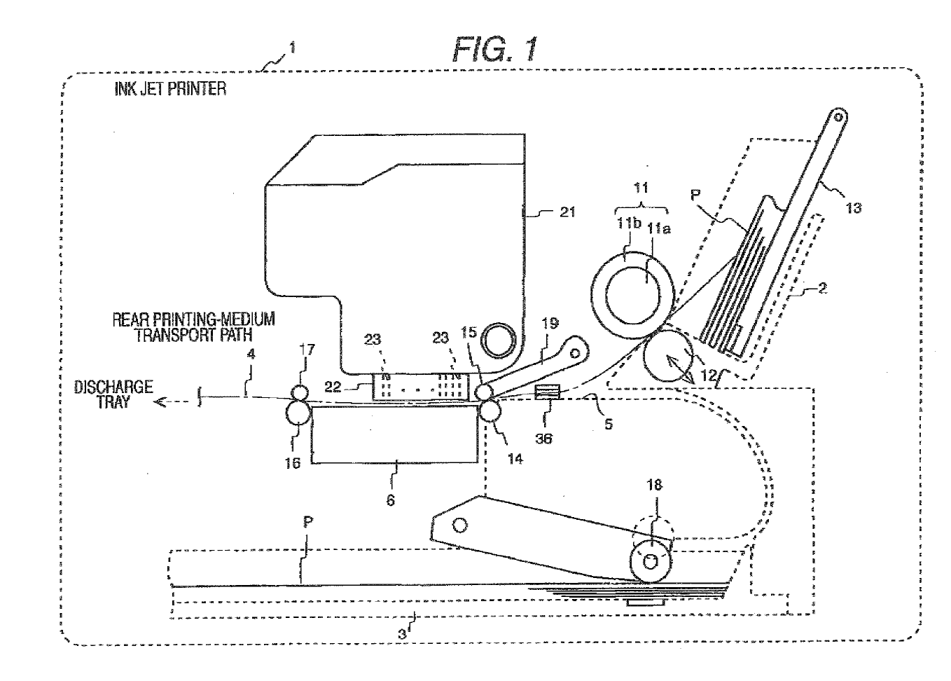

FIG. 1 is a side view illustrating a part of a mechanism structure of an ink jet printer according to an embodiment of the invention.

An ink jet printer 1 has a rear feed tray 2 and a front feed tray 3 as a feed tray. The rear feed tray 2 is disposed to protrude upward from a back portion of the ink jet printer 1. The front feed tray 3 is disposed to be substantially parallel to a bottom portion of the ink jet printer 1. The rear feed tray 2 and the front feed tray 3 can receive a variety of printing mediums such as sheets of regular paper, glossy paper, photo paper, postcard paper, and L-size photo paper.

The printing mediums P placed on the rear feed tray 2 and the front teed tray 3 are transported along a predetermined printing-medium transport path and are discharged to a discharge tray (not shown) disposed on the front side of the ink jet printer 1. In FIG. 1, a rear printing-medium transport path 4 as the printing-medium transport path is indicated by a dot-dashed line. A guide member 5 regulating the transport direction of the printing mediums P or a platen 6 is disposed along the rear printing-medium transport path 4

The ink jet printer 1 includes mechanism members for transporting the printing mediums P placed on the rear feed tray 2, such as a load (LD) roller 11, an LD follower roller 12, a hopper 13, a paper feed (PF) roller 14, a PF follower roller 15, a discharge roller 16, and a discharge follower roller 17. The ink jet printer 1 further includes a mechanism member for transporting the printing mediums P placed on the front feed tray 3, such as a second LD roller 18.

The LD roller 11 is disposed to be rotatable adjacent to the lower edge at the rear feed tray 2. The LD roller 11 includes a roller shaft 11a having an axis perpendicular to the paper plane of FIG. 1 and a rubber member 11b provided around the roller shaft. The LD roller 11 is formed in a substantially cylindrical shape. The LD roller 11 rotates with the actuation of an auto sheet feeder (ASF) motor 32 to be described later.

The LD follower roller 12 has a cylindrical shape having a width substantially equal to that of the LD roller 11 and is rotatably disposed below the LD roller 11. The LD follower roller 12 moves to be contacted with and separated from the LD roller 11 with the actuation of an ASF sub motor 33 to be described later. The LD roller 11 and the LD follower roller 12 come in contact with each other in the vicinity of the lower edge of the rear feed tray 2. The LD roller 11 and the LD follower roller 12 come in pressing contact with each other with a predetermined pressing force.

The hopper 13 is disposed so that the lower portion of the rear feed tray 2 is pivotable. The hopper 13 changes its posture to come close to the LD roller 11 when the LD follower roller 12 comes in pressing contact with the LD roller 11, and changes its posture to be separated from the LD roller 11 when the LD follower roller 12 is separated from the LD roller 11. When printing mediums P are placed on the rear feed tray 2, the lower end of the uppermost printing medium P comes in contact with the LD roller 11 by allowing the hopper 13 to come close to the LD roller 11. The uppermost printing medium P on the rear feed tray 2 is nipped between the hopper 13 and the LD roller 11.

The PF roller 14 is disposed below the rear printing-medium transport path 4 between the guide member 5 and the platen 6. The PF roller 14 is formed in a cylinder shape out of a metal material and is disposed to be rotatable in a state where the axis direction of the cylinder is substantially perpendicular to the paper plane of FIG. 1. Slide-preventing ceramic particles are fixed to the outer peripheral surface of the metal rod so as to form micro unevenness on the outer peripheral surface. The PF roller 14 rotates with the actuation of the PF motor 31 to be described later.

The PF follower roller 15 has a cylinder shape having a width substantially equal to that of the PF roller 14 and is rotatably disposed above the PF roller 14. The PF follower roller 15 is held by a PF-follower-roller arm 19. An urging force which is downward in FIG. 1 acts on the PF-follower-roller arm 19 by a spring not shown. Accordingly, the PF follower roller 15 comes in pressing contact with the PF roller 14 with a large pressing force.

Accordingly, the transport capability (the total transport capability including a holding force) of the printing medium P by the PF roller 14 and the PF follower roller 15 which are in contact with each other is higher than the transport capability of the printing medium P by the LD roller 11 and the LD follower roller 12 which are in contact with each other. Accordingly, when a sheet of printing medium P is nipped between the PF roller 14 and the PF follower roller 15 and is also nipped between the LD roller 11 and the LD follower roller 12, the transport distance of the printing medium P is under a transport control using the PF roller 14 and the PF follower roller 15.

The discharge roller 16 is rotatably disposed below the rear printing-medium transport path 4 between the platen 6 and a discharge tray not shown. The discharge roller 16 rotates with the actuation of the PF motor 31 to be described later.

The discharge for lower roller 17 is rotatably disposed above the discharge roller 16. The discharge follower roller 17 comes in pressing contact with the discharge roller 16 with a small pressing force.

The ink jet printer 1 has a printing mechanism for ejecting ink to the printing medium P to perform a printing operation, such as a carriage 21, in addition to the above mentioned transport mechanism of the printing mediums P.

The carriage 21 is disposed above the platen 6 so as to be movable in a direction perpendicular to the paper plane of FIG. 1. For example, an ink tank not shown and the like are disposed inside the carriage 21. The carriage 21 moves in the direction perpendicular to the paper plane of FIG. 1 with the actuation of a carriage (CR) motor not shown.

A print head 22 is disposed on the bottom of the carriage 21 so as to be opposed to the platen 6. The print head 22 has plural ink ejection nozzles 23. The plural ink ejection nozzles 23 are supplied with the ink from the ink tank. The plural ink ejection nozzles 23 are arranged, for example, in the transport direction of the printing medium P. A piezoelectric element not shown is disposed in each ink ejection nozzle 23. The piezoelectric element is deformed with the applied voltage. When each piezoelectric element is deformed, the amount of ink corresponding to the deformation is extruded from the corresponding ink ejection nozzle 23 and is ejected from the corresponding ink ejection nozzle 23. The ink ejected from the plural ink ejection nozzles 23 is adhered to a portion of the printing medium P between the platen 6 and the print head 22.

By applying voltages of waveforms corresponding to print data to the plural piezoelectric elements while moving the carriage 21 in the direction perpendicular to the paper plane of FIG. 1, it is possible to adhere the ink to the portion of the printing medium P between the platen 6 and the print head 22 on the basis of the print data. By repeatedly performing the printing process and the paper feeding process of feeding the printing medium P by a predetermined distance, the ink jet printer 1 can print an image based on the print data on the printing medium P.

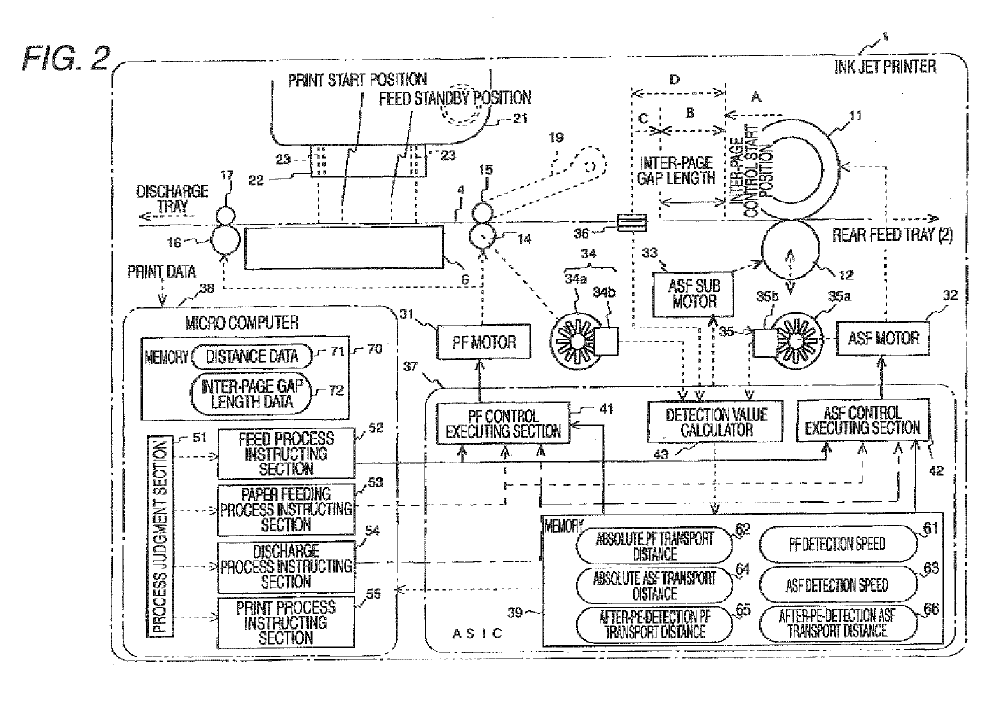

FIG. 2 is a block diagram illustrating a partial configuration of a control system of the ink jet printer 1 shown in FIG. 1. The rear printing-medium transport path 4 and various mechanism members disposed along the path are schematically illustrated in the upper portion of FIG. 2. As a control reference position, an inter-page control start position, a feed standby position, and a print start position are set in the rear printing-medium transport path 4.

The inter-page control start position is set in the transport path of the printing mediums P between the LD roller 11 and the PF roller 14. The inter-page control start position is a reference position for executing a control for setting a predetermined inter-page gap length (predetermined inter-paper distance) between two printing mediums P continuously transported when the plural printing mediums P placed on the rear feed tray 2 are continuously transported. The printing medium P subsequently transported is stopped when its leading end edge reaches the inter-page control start position. When the trailing end edge of the printing medium P previously transported is spaced apart by a predetermined inter-page gap length from the inter-page control start position, the transport of the printing medium P subsequently transported is resumed. By executing such an inter-page control, it is possible to set the inter-page gap length between the plural printing mediums F continuously transported. The inter-page control start position is preferable set within a range in which the printing medium P can be restored to the rear feed tray 2 by a restoring arm (not shown) rotating in a direction opposite to the transport direction of the printing medium P around the LD follower roller 12 in the course of executing a control for moving the LD follower roller 12 separated from the LD roller 11 to a predetermined retreating position.

The feed standby position is a target stop position of the leading end edge of the printing medium P in a usual feed process. The feed standby position is set to a position separated downstream by a predetermined distance (for example r 3 to 5 mm) from the most upstream nozzle (close to the rear feed tray 2) in the transport direction of the printing mediums P among the plural ink ejection nozzles 23 formed in the print head 22.

The print start position is a target stop position of the leading end edge of the printing medium P at the time of starting a printing operation an the printing medium P. The print start position is set to a position separated upstream by a predetermined distance (for example, 3 to 5 mm) from the most downstream nozzle (close to the discharge tray) in the transport direction of the printing mediums P among the plural ink ejection nozzles 23 formed in the print head 22.

In this way, by providing the feed standby position more upstream in the transport direction of the printing mediums P than the print start position, the printing medium P is temporarily stopped at the feed standby position and then is fed to the print start position in the usual feed process. Accordingly, compared with the case where the printing medium P is transported at a time from the rear feed tray 2 to the print start position by means of one time of control, it is possible to enhance the precision of the stop position of the printing medium P relative to the print start position.

In the following description, it is assumed that a range from the rear feed tray 2 to the inter-page control start positions referred to as area A, a range from the inter-page control start position to a position separated downstream by the inter-page gap length therefrom is referred to as area B, and a range from the position separated by the inter-page gap length to the discharge tray is referred to as area C.

The ink jet printer 1 includes a PF motor 31 for driving the PF roller 14 and the discharge roller 16 to rotate, an ASF motor 32 for driving the LD roller 11 to rotate, an ASF sub motor 33 contacting and separating the LD follower roller 12 with and from the LD roller 11, a CR motor not shown, a PF rotary encoder 34, an ASF rotary encoder 35, a page edge (PE) sensor 36 as a sensor, an ASIC (Application Specification Integrated Circuit) 37, and a micro computer 38

A pulse motor such as a DC (direct current) motor and a stepping motor can be used for the PF motor 31, the ASF motor 32, the ASF sub motor 33, and the CR motor. The DC motor rotates at a rated speed when a predetermined DC voltage is applied thereto. When the applied voltage is controlled in a PWM (Pulse Width Modulation) manner, the DC motor rotates at a speed corresponding to a duty ratio lower than the rated speed. The DC motor rotates inversely when the polarity of the DC voltage is inverted.

The PF rotary encoder 34 has a PF scale plate 34a rotating along with the PF roller 14 and a PF photo interrupter 34b for detecting plural slits formed along the outer periphery of the PF scale plate 34a. When the PF scale plate 34a rotates together with the PF roller 14, the PF photo interrupter 34b of the PF rotary encoder 34 generates a detection signal of which the level varies with the detection of the slits. The detection signal has a pulse waveform. The pulse period of the detection signal varies with the rotation speed of the PF scale plate 34a. For examples when the rotation speed of the PF scale plate 34a is enhanced, the pulse period of the detection signal is shortened.

The ASF rotary encoder 35 includes an ASP scale plate 35a rotating along with a rotor of the ASF motor 32 and an ASF photo interrupter 35b for detecting plural slits formed along the outer periphery of the ASF scale plate 35a. The rotation amount of the rotor of the ASF motor 32 has a predetermined relation with the rotation amount of the LD roller 11. The rotation amount of the ASF scale plate 35a can correspond to the rotation amount of the LD roller 11. When the ASF scale plate 35a rotates together with the ASF motor 32 and the LD roller 11, the ASF photo interrupter 35b of the ASF rotary encoder 35 generates a detection signal which has a pulse waveform and of which the level varies with the detection of the slits.

In the PE sensor 36, a light-emitting element and a light-receiving element not shown are opposed to each other with a predetermined gap therebetween. The PE sensor 36 is disposed so that the rear printing-medium transport path 4 is located between the light-emitting element and the light-receiving element. The PS sensor 36 is disposed at a position separated downstream by at least the inter-page gap length from the inter-page control E start position and between the LD roller 11 and the PF roller 14. The light-receiving element of the PE sensor 36 outputs a detection signal which varies depending on the light-receiving state of the light emitted from the light-emitting element. The PE sensor 36 outputs a detection signal which varies depending on the existence or absence of the printing medium P between the light-emitting element and the light-receiving element.

The ASIC 37 is a kind of a micro computer and includes a memory 39, a CPU (Central Processing Unit) not shown, a timer, and an input/output port. The detection signal of the PF rotary encoder 34, the detection signal of the ASF rotary encoder 35, and the detection signal of the PE sensor 36 are input to the input/output port. By allowing the CPU not shown to execute a predetermined program, the ASIC 37 embodies a PF control executing section 41, an ASE control executing section 42, and a detection value calculator 43.

The micro computer 38 includes a memory 70, a CPU not shown, a timer, and an input/output port. The memory 70 of the micro computer 38 stores distance data 71 as data on the inter-page control start position (predetermined control start position) and data on the inter-page gap length 72. The distance data 71 is data on the distance, which is indicated by distance D in FIG. 2, from the inter-page control start position to the detection position of the PF sensor 36. Distance D is greater than the inter-page gap length. The input/output port of the micro computer 38 is connected to the input/output port of the ASIC 37. By allowing the CPU not shown to execute a predetermined program, the micro computer 38 embodies a process judgment section 51, a feed process instructing section 52, a paper feeding process instructing section 53, a discharge process instructing section 54, and a print process instructing section 55.

The program executed by the CPU of the ASIC 37 may be stored, for example, in the memory 39 or the like of the ASIC 37. The program executed by the CPU of the micro computer 38 may be stored, for example, in the memory 70 or the like of the micro computer 38. The programs or parts thereof may be stored in the memories 39 and 70 before shipping the ink jet printer 1 or may be stored in the memories 39 and 70 after shipping the ink jet printer 1. The programs or parts thereof stored in the memories 39 and 70 after shipping the ink jet printer 1 may be those which have been recorded in a computer-readable recording medium such as a CD-ROM and have been read and stored in the memories 39 and 70 by the use of a personal computer connected to the ink jet printer 1, or may be those which have stored in a server unit and have been downloaded through a transmission medium such as Internet and stored in the memories 39 and 70 by the use of the personal computer connected to the ink jet printer 1.

The detection value calculator 43 embodied by the ASIC 37 generates various detection values on the basis of the detection signal of the PF rotary encoder 34, the detection signal of the ASF rotary encoder 35, and the detection signal of the PE sensor 36 which are input to the ASIC 37 and updates the data stored in the memory 39. The detection value calculator 43 periodically generates various detection values, for example, with a PID control period and updates the memory 39

Specifically, the detection value calculator 43 measures the number of pulses per unit time in the detection signal of the PF rotary encoder 34 as a PF interval pulse number. The detection value calculator 43 stores the PF interval pulse number in the memory 39 as a PF detection speed 61 representing a transport speed by the PF roller 14

The detection value calculator 43 measures a cumulative number of pulses in the detection signal of the PF rotary encoder 34 as a PT cumulative pulse number. The detection value calculator 43 stores the PF cumulative pulse number in the memory 39 as an absolute PF transport distance 62 representing a cumulative transport distance by the PF roller 14.

The detection value calculator 43 measures the number of pulses per unit time in the detection signal of the ASF rotary encoder 35 as an ASF interval pulse number. The detection value calculator 43 stores the ASF interval pulse number in the memory 39 as an ASF detection speed 63 representing a transport speed by the LD roller 11.

The detection value calculator 43 measures a cumulative number of pulses in the detection signal of the ASF rotary encoder 35 as an ASF cumulative pulse number. The detection value calculator 43 stores the ASF cumulative pulse number in the memory 39 as an Absolute ASF transport distance 64 representing a cumulative transport distance by the LD roller 11.

The detection value calculator 43 judges whether the printing medium P is detected by the PE sensor 36, on the basis of the level of the detection signal of the PE sensor 36. When the printing medium P is detected, the detection value calculator 43 counts the number of pulses in the detection signal of the PF rotary encoder 34 after the detection. The detection value calculator 43 stores the counted number of pulses in the memory 39 as an after-PE-detection PF transport distance 65. When the printing medium P is detected, the detection value calculator 43 counts the number of pulses in the detection signal of the ASF rotary encoder 35 after the detection. The detection value calculator 43 stores the counted number of pulses in the memory 39 as an after-PE-detection ASF transport distance 66.

The PF control executing section 41 controls the actuation of the PF motor 31. The PF control executing section 41 generates an instantaneous current value for controlling the driving speed or the rotation direction of the PF motor 31 so that the PF detection speed 61 stored in the memory 39 complies with a predetermined speed profile. The PF control executing section 41 generates an instantaneous current value so as to stop with a transport distance based on an instruction or the like.

The ASF control executing section 42 controls the actuation of the ASF motor 32. The ASF control executing section 42 generates an instantaneous current value for controlling the driving speed or the rotation direction of the ASE motor 32 so that the ASF detection speed 63 stored in the memory 39 complies with a predetermined speed profile. The ASF control executing section 42 generates an instantaneous current value so as to stop with a transport distance based on an instruction or the like.

The feed process instructing section 52 embodied by the micro computer 38 generates an instruction for performing a feed process of transporting a non-printed printing medium P, for example, from the rear feed tray 2 to a print start position. Specifically, the feed process instructing section 52 instructs the PF control executing section 41 to perform a feed control and instructs the ASF control executing section 42 to perform a feed control. The feed process instructing section 52 gives an instruction for actuating the ASF sub motor 33 to the ASIC 37.

The paper feeding process instructing section 53 generates an instruction for performing a paper feeding process of transporting a printing medium P, which is being fed in a printing area between the print head 22 and the platen 6, by a predetermined distance. Specifically, the paper feeding process instructing section 53 instructs a target PF transport distance to the PF control executing section 41. In a continuous print mode in which plural printing mediums P are continuously transported for print, the paper feeding process instructing section 53 a target ASF transport distance to the ASP control executing section 42.

The discharge process instructing section 54 generates an instruction for performing a discharge process of transporting a printing medium P, which has been fed to the printing area, for example, from the printing area to the discharge tray. Specifically, the paper feeding process instructing section 53 instructs the target PF transport distance to the PF control executing section 41. In the continuous print mode, the discharge process instructing section 54 instructs the target ASF transport distance to the ASP control executing section 42.

The print process instructing section 55 generates an instruction for once scanning a printing medium P having been fed to the printing area. Specifically, the print process instructing section 55 instructs the ASIC 37 to actuate the CR motor not shown and instructs to apply voltages of waveforms corresponding to the print data to the plural piezoelectric elements in a state where the print head 22 is opposed to the printing medium P.

The process judgment section 51 judges the state when the ink j et printer 1 is stopped. Then, the process judgment section 51 selects one out of the plural process instructing sections of the feed process instructing section 52, the paper feeding process instructing section 53, the discharge process instructing section 54, and the print process instructing section 55 as the judgment result and instructs the selected process instructing section to perform its process.

For example, when print data are supplied to the ink jet printer from a personal computer not shown and the ink jet printer is in a printable state, the process judgment section 51 sequentially selects one of the feed process instructing section 52, the paper feeding process instructing section 53, the discharge process instructing section 54, and the print process instructing section 55 and instructs the selected process instructing section to perform its process every selection, so as to perform a printing operation based on the print data. When the printing operation is performed normally, the process judgment section 51 first selects the feed process instructing section 52, alternately selects the print process instructing section 55 and the paper feeding process instructing section 53 until the non-printed print data do not remain, and selects the discharge process instructing section 54 when the non-printed print data do not remain. Accordingly, the printing medium P is fed to the printing area opposed to the print head 22, is subjected to the printing operation based on the print data by repeating the printing scan and the paper feeding by a predetermined distance, and then is discharged to the discharge tray.

Next, operations of the ink jet printer 1 according to the embodiment having the above-mentioned configuration will be described. Were, the operation in the continuous print mode will be specifically described.

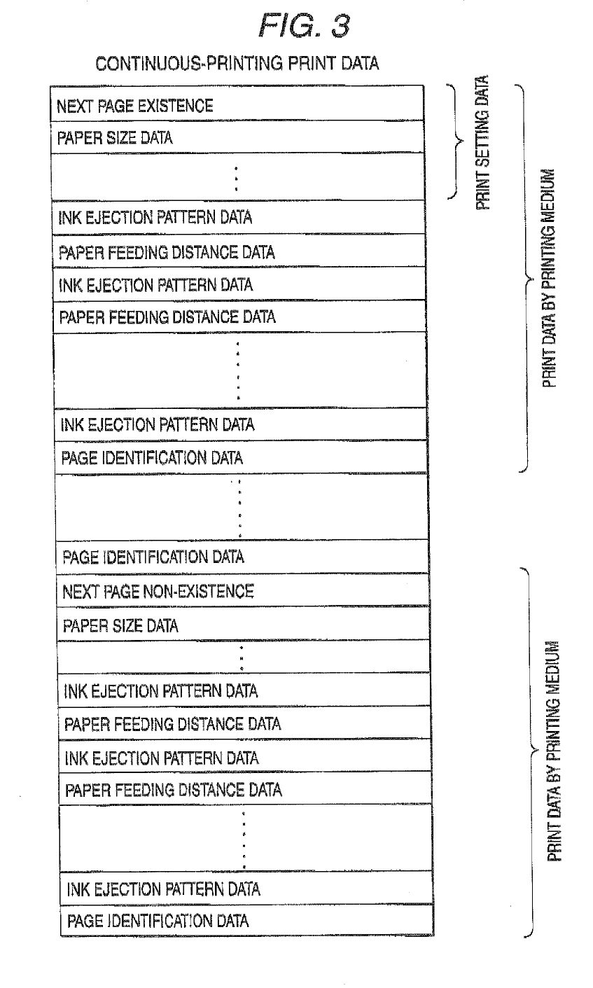

FIG. 3 is a diagram illustrating a data structure of continuous-printing print data supplied to the ink jet printer 1 shown in FIG. 1.

The continuous-printing print data supplied to the ink jet printer 1 includes print data by printing medium which is used to control the printing operation on the corresponding printing medium P. The print data by printing medium includes print setting data for specifying a size of a sheet to be subjected to the printing operation, plural ink ejection pattern data in which at image to be printed on the printing medium P is divided, for example, by a print width, plural paper feeding distance data interposed between two continuous ink ejection pattern data, and page identifying data. The plural ink ejection pattern data and the plural paper feeding distance data are alternately arranged in the print data by printing medium.

The print setting data includes sheet size data for specifying a size of a sheet to be subjected to the printing operation. In a continuous printing operation, the sheet size data included in the print data by printing medium are constant basically. The print setting data in the continuous printing operation additionally include next page existence data or next page non-existence data. When it is assumed that the number of pages is n (where n is an integer equal to or greater than 2), the next page existence data is included in the print data by printing medium of the first to (n−1)-th page and represents that a next printing page exists. The next page non-existence data is included in the print data by printing medium of the n-th page and represents that a next printing page does not exist. The print setting data is asked to the print data by a printer driver not shown and installed in a personal computer communicating with the ink jet printer 1 at the time of generating the print data. In controlling the continuous printing operation to be described later, the control can be performed even when the next page non-existence data is not included.

The continuous-printing print data are generated when a high-speed printing operation on plural sheets of regular paper in which the rear feed tray 2 of the ink jet printer 1 is designated is specified in the personal computer. In the other printing operation, for example, when the printing operation is performed on a sheet of exclusive-use paper, the personal computer generates the usual print data. The usual print data has a data structure which is obtained by removing the next page existence data or the next page non-existence data from the print data by printing medium shown in FIG. 3.

When the continuous-printing print data having the above-mentioned data structure are supplied, the ink jet printer 1 performs a printing operation in the continuous print mode The ink jet printer 1 performs the printing operation while to continuously transporting plural printing mediums P placed on the rear feed tray. Similarly to the usual print mode, the process judgment section 51 of the ink jet printer 1 first selects the feed process instructing section 52, alternately selects the print process instructing section 55 and the paper feeding process instructing section 53 until the non-printed print data does not remain, and then selects the discharge process instructing section 54 when the non-printed print data does not remain, every printing medium P. The process judgment section 51 transports the printing mediums F of the number of sheets designated by the continuous-printing print data and performs the printing operation on the printing mediums.

Now, detailed printing operations of the ink jet printer 1 in the continuous print mode will be described.

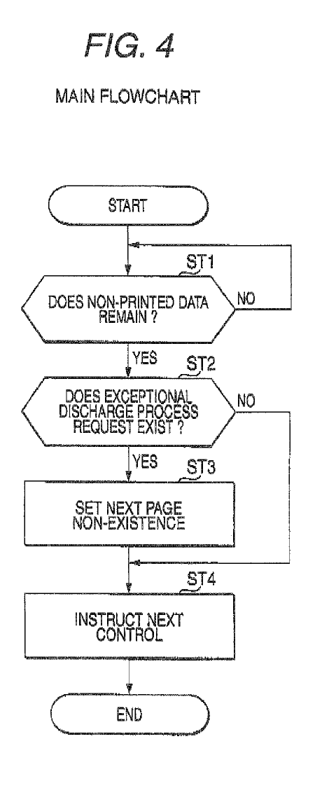

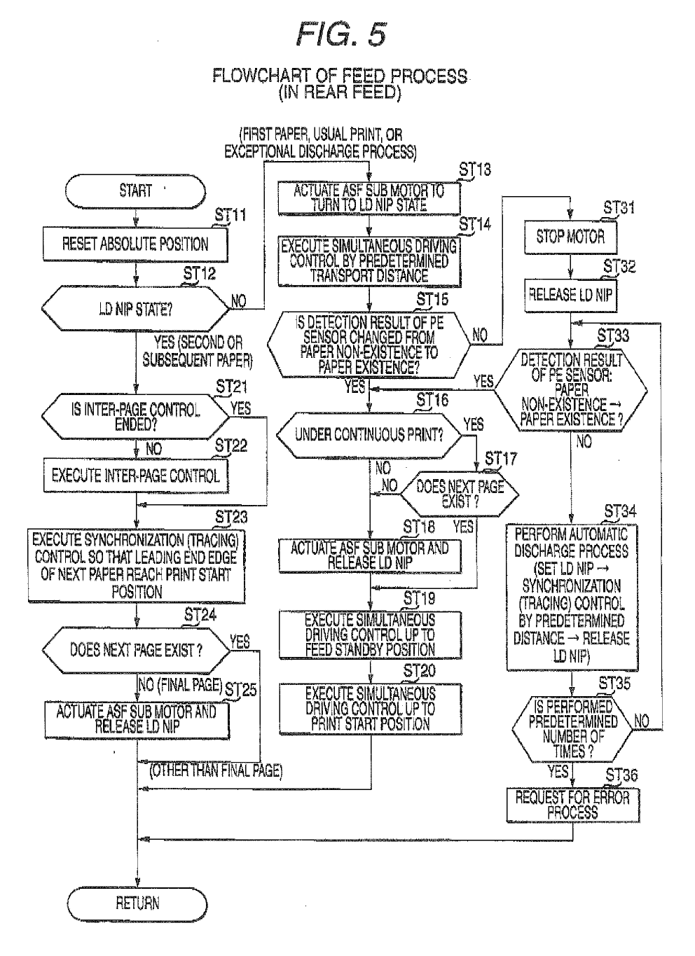

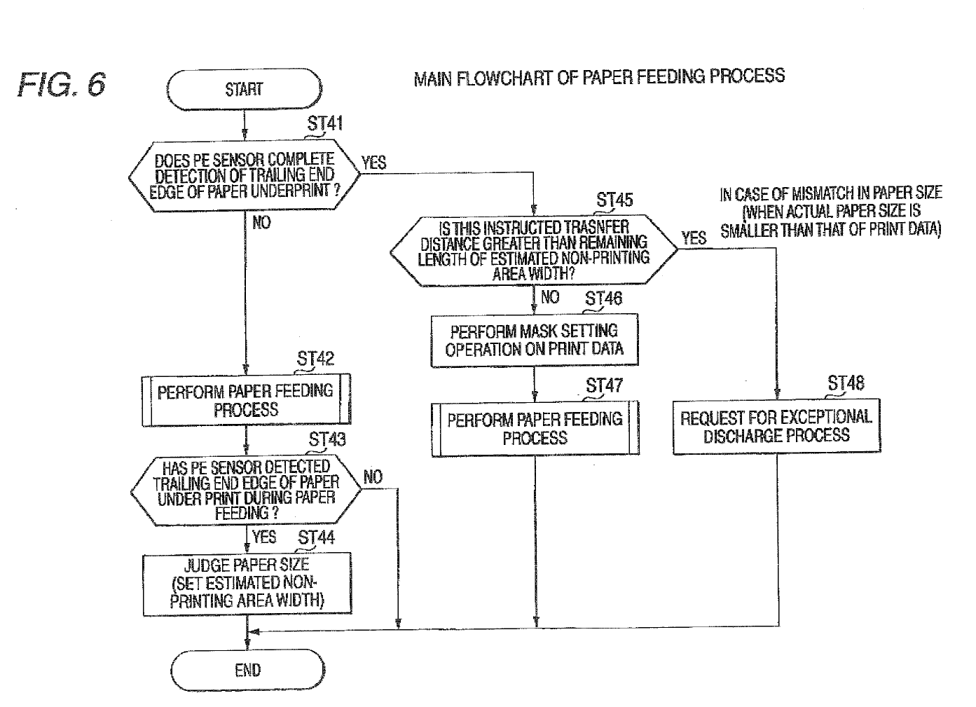

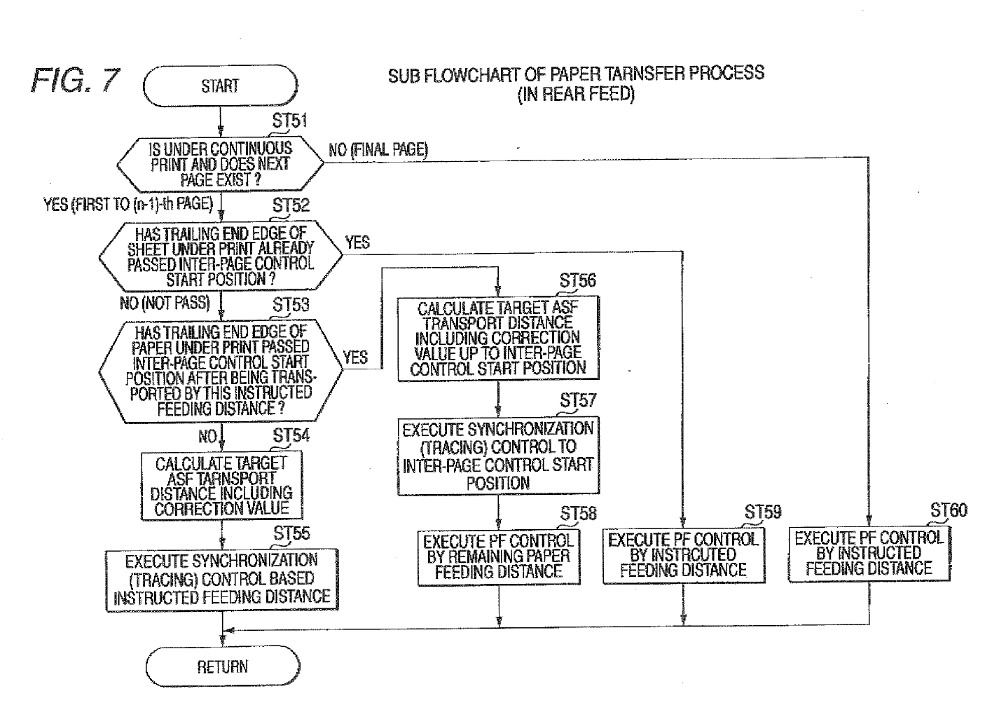

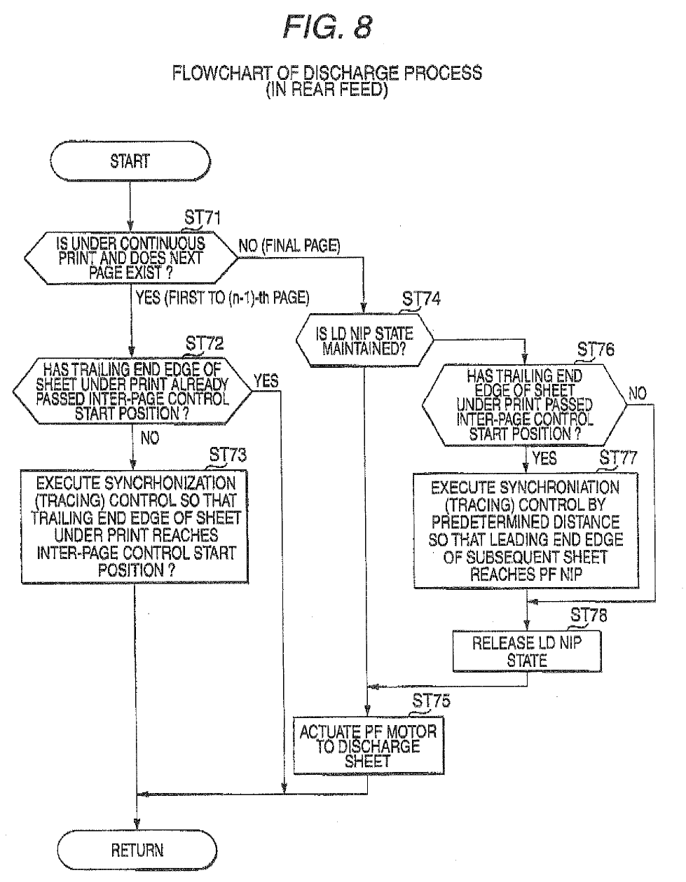

FIG. 4 is a flowchart illustrating a main flow of a print process that is performed by the process judgment section 51 shown in FIG. 2 in a continuous print mode. FIG. 5 is a flowchart illustrating a flow of a feed process that is performed by the feed process instructing section 52 shown in FIG. 2 in the continuous print mode. FIG. 6 is a flowchart illustrating a flow of a paper feeding process that is performed by the paper feeding process instructing section 53 shown in FIG. 2 in the continuous print mode. FIG. 7 is a flowchart illustrating a sub flow of the paper feeding process that is performed by the paper feeding process instructing section 53 shown in FIG. 2 in the continuous print mode. FIG. 8 is a flowchart illustrating a flow of a discharge process that is performed by the discharge process instructing section 54 shown in FIG. 2 in the continuous print mode.

When the continuous-printing print data shown in FIG. 3 is supplied to the ink jet printer 1, the process judgment section 51 judges that non-printed data remains (step ST1) and starts a data process, as shown in FIG. 4. The process judgment section 51 first checks that the ink jet printer 1 is in a printable state. The process judgment section 51 checks that there is no request for an exceptional discharge process due to, for example, a difference in paper size (No in step ST2). Thereafter, the process judgment section 51 reads data from the head of the continuous-printing print data. The process judgment section 51 reads print setting data of the print data of the first printing medium and instructs the feed process instructing section 52 to perform its process (step ST4).

A reception buffer for print data (not shown) of the ink jet printer 1 is limited in physical capacity. Accordingly, the continuous-printing print data are divided into plural pieces depending on the empty state of the reception buffer and are supplied to the ink jet printer 1. In this situation, the process judgment section 51 can read data from the head of the continuous-printing print data. The limitation in physical capacity of the reception buffer does not cause any problem in control.

The feed process instructing section 52 instructed to perform its process performs the flowchart of the teed process shown in FIG. 5. The feed process instructing section 52 first resets the absolute PF transport distance 62 and the absolute ASF transport distance 64 stored in the memory 39 of the ASIC 37 to “0” (step ST11). Accordingly the absolute PF transport distance 62 and the absolute ASF transport distance 64 represent a transport distance after starting the feed process on the respective printing mediums P.

After resetting the absolute position, the feed process instructing section 52 checks whether the LD follower roller 12 is in an LD nip state where it is in contact with the LD roller 11 (step ST12). At the time of continuously feeding the printing mediums P, the LD follower roller 12 is maintained in the nip state in contact with the LD roller 11. Accordingly, by checking the LD nip state, the feed process instructing section checks whether this feed process is for the second or subsequent printing medium in the continuous print. It is assumed that this feed process is for a first printing medium in the continuous print. Accordingly, the feed process instructing section 52 judges No in step ST12.

When judging that it is not for the second or subsequent printing medium in the continuous print, the feed process instructing section 52 instructs the ASIC 37 to actuate the ASF sub motor 33 (step ST13). The ASIC 37 actuates the ASF sub motor 33. Accordingly, the LD follower roller 12 comes in pressing contact with the LD roller 11. The hopper 13 interposes the plural printing mediums P on the rear feed tray 2 between the LTD roller 11 and the LD follower roller.

After actuating the ASF sub motor 33 to bring the LD follower roller 12 into pressing contact with the LD roller 11, the feed process instructing section 52 instructs the PF control executing section 41 and the ASF control executing section 42 to start a simultaneous driving control to be described later (step ST14). Specifically, the feed process instructing section 52 instructs the ASF control executing section 42 to perform a feed control by a predetermined transport distance. The ASF control executing section 42 starts the actuation of the ASF motor 32. The LD roller 11 starts its rotation with the actuation of the ASF motor 32. The uppermost printing medium P coming in contact with the LD roller 11 starts its transport with the rotation of the LD roller 11. The feed process instructing section 52 instructs the PF control executing section 41 to execute the feed control by the predetermined transport distance. The PF control executing section 41 starts the actuation of the PF motor 31. The PF toiler 14 starts its rotation with the actuation of the PF motor 31.

The LD follower roller 12 is in pressing contact with the LD roller 11. Accordingly, even when a printing medium P other than the uppermost printing medium P, for example, the second upper printing medium P, starts its transport along with the uppermost printing medium P with the rotation of the LD roller 11, the printing medium P other than the uppermost printing medium P can hardly pass through the nip position between the LD roller 11 and the LD follower roller. The LD follower roller 12 serves as a load for hindering the second printing medium P from being transported.

When the ASF motor 32 is actuated, the ASF rotary encoder 35 starts outputting the detection signal having a pulse waveform. The detection value calculator 43 updates the ASF detection speed 63 and the absolute ASF transport distance 64 in the memory 39 on the basis of the detection signal. Similarly, when the PF motor 32 is actuated, the PF rotary encoder 34 starts outputting the detection signal having a pulse waveform. The detection value calculator 43 updates the PF detection speed 61 and the absolute PT transport distance 62 in the memory 39 on the basis of the detection signal.

The ASE control executing section 42 having started the actuation of the ASF motor 32 reads the ASF detection speed 63 stored in the memory 39 with a predetermined period such as a PID control period. The ASF control executing section 42 generates an instantaneous current value having a PID control value corresponding to a deviation of the ASF detection speed 63 from the target ASF speed. The rotation speed of the ASF motor 32 varies depending on the instantaneous current value. The ASH control executing section 42 executes the PID control so that the ASF detection speed 63 complies with a predetermined speed profile. The printing medium P is transported at a predetermined speed. The PF control executing section 41 also executes the PID control so that the PF detection speed 61 stored in the memory 39 reaches the predetermined speed.

The printing medium P having started its transport with the rotation of the LD roller 11 moves toward the discharge tray along the rear printing-medium transport path 4. The printing medium P passes the PE sensor 36 and then is nipped between the PF roller 14 and the PF follower roller 15.

When the leading end edge of the printing medium P goes between the light-emitting element and the light-receiving element of the PE sensor 36, the detection signal of the PE sensor 36 is changed from sheet existence to sheet non-existence. When the sheet of printing medium is detected by the PE sensor 36, the detection value calculator 43 starts updating the After-PE-detection PF transport distance 65 and the After-PE-detection ASF transport distance 66 stored in the memory 39. At this time, the actuation of the PF motor 31 is not started. The detection value calculator 43 repeatedly updates the After-PE-detection PE transport distance 65 to “0”.

The detection value calculator 43 updates the After-PE-detection PF transport distance 65 on the basis of the transport distance of the LD roller 11 calculated based on the detection signal of the PF rotary encoder 34 after the printing medium P is detected by the PE sensor 36. The detection value calculator 43 updates the After-PE-detection ASF transport distance 66 on the basis of the transport distance of the LD roller 11 calculated based on the detection signal of the ASF rotary encoder 35 after the printing medium P is detected by the PE sensor 36.

The detection value calculator 43 may always update the After-PE-detection PF transport distance 65 or the After-PE-detection ASF transport distance 66 on the basis of the detection signal of the ASF rotary encoder 35 or the PF rotary encoder 34.

The feed process instructing section 52 judges that the detection result of the PE sensor 36 is changed from paper existence to paper non-existence (step ST15), after starting rotationally driving the LD roller 11 in step (step ST15). The feed process instructing section 52 judges whether this feed process is for a continuous print (step ST16). When this feed process is in the continuous print mode, the feed process instructing section 52 judges whether a next page remains to be printed (step ST17). The teed process instructing section 52 can judge that this feed process is in the continuous print mode and a next page remains to be printed, for example, when next page existence data is included in the print data by printing medium. It is assumed that this feed process is for the first printing medium in the continuous print and a next page remains to be printed. Accordingly, the feed process instructing section 52 judges Yes in step ST17 and starts a simultaneous driving control to be described later up to the feed standby position (step ST19). The LD follower roller 12 is kept in pressing contact with the LD roller 11.

When this feed process is not in the continuous print mode (No in step ST16) or when a next page does not remain (No in step ST17), the feed process instructing section 52 instructs the ASIC 37 to release the flip state (stop ST18). The ASIC 37 actuates the ASF sub motor 33 to separate the LD follower roller 12 from the LD roller 11.

Next, the feed process instructing section 52 executes the simultaneous driving control to be described later up to the feed standby position (step ST19). The feed process instructing section 52 instructs the PF control executing section 41 to actuate the PF motor 31 and instructs the ASF control executing section 42 to actuate the ASF motor 32. The PF control executing section 41 starts actuating the PF motor 31. The ASF control executing section 42 starts actuating the ASF motor 32. The PF roller 14 and the PF follower roller 15 start their rotations along with the LD roller 11 and the LD follower roller 12. The printing medium starts its transport to the printing area with the rotations of the LD roller 11, the LD follower roller 12, the PF roller 14, and the PF follower roller 15.

When the PF motor 31 is actuated, the PF rotary encoder 34 starts outputting the detection signal of a pulse waveform with the rotation of the PF roller 14. The detection value calculator 43 updates the PF detection speed 61, the absolute PF transport distance 62, and the After-PE-detection PF transport distance 65 in the memory 39. The After-PE-detection PF transport distance 65 is updated to a value other than “0”. The PF control executing section 41 actuating the PF motor 31 reads the PF detection speed 61 stored in the memory 39 with a predetermined period such as a PID control period. The PF control executing section 41 generates an instantaneous current value having a PID control value corresponding to the deviation of the PE detection speed 61 from the target PF speed. The rotation speed of the PF motor 31 varies depending on the instantaneous current value. The PF control executing section 41 performs a PID control so that the PF detection speed 61 complies with a predetermined speed profile. The printing medium P is transported a predetermined speed.

The PF control executing section 41 instructed to perform the feed control periodically reads the After-PE-detection PF transport distance 65 stored in the memory 39 of the ASIC 37. When the read after-PE-detection PF transport distance 65 reaches a predetermined transport distance, the PF control executing section 41 starts a deceleration control with a predetermined number of pulses so as to stop the PF motor 31. The PF control executing section 41 reduces a current instruction value to the PF motor 31 and stops.

Similarly, the ME control executing section 42 periodically reads the absolute ASF transport distance 64 stored in the memory 39 of the ASIC 37. When the read after-PE-detection ASF transport distance 66 reaches a predetermined transport distance, the ASF control executing section 42 starts a deceleration control with a predetermined number of pulses so as to stop the PF motor 31. The ASF control executing section 42 reduces a current instruction value to the ASF motor 32 and stops.

In this way, the uppermost printing medium P placed on the rear feed tray 2 is fed so that the leading end edge thereof is stopped at the feed standby position. The first printing medium P is fed to the feed standby position by the simultaneous driving control of the PF motor 31 and the ASF motor 32.

When feeding the first printing medium P to the feed standby position, the feed process instructing section 52 instructs the PF control executing section 41 and the ASF control executing section 42 to perform the feed control to the print start position. The PF control executing section 41 and the ASF control executing section 42 further transport the printing medium P to the print start position by the simultaneous driving control of the PF motor 31 and the ASF motor 32 (step ST20).

When the feed process under the simultaneous driving control is finished, the feed process instructing section 52 ends the feed process on the first printing medium. The PF roller 14 and the LD roller 11 are stopped. The PF detection speed 61 and the ASF detection speed 63 stored in the memory 39 of the ASIC 37 are updated to “0”. The process judgment section 51 judges that non-printed data remains (Yes in step ST1 of FIG. 4) and checks that a request for an exceptional discharge process due to the mismatch in paper size is not given (No in step ST2). Thereafter, the process judgment section 51 successively reads the print data of the first printing medium out of the continuous-printing print data. The process judgment section 51 reads first ink ejection pattern data out of the print data of the first printing medium and instructs the print process instructing section 55 to perform its process (step ST4).

The print process instructing section 55 instructed to perform its process performs the print process. The print process instructing section 55 supplies the ASIC 37 with the ink ejection pattern data and instructs the ASIC to actuate the CR motor not shown. The carriage 21 moves with the actuation of the CR motor by the ASIC 37. With the plural ink ejection nozzles 23 of the print head 22 opposed to the fed printing medium P, the ASIC 37 applies voltages of waveforms based on the ink ejection pattern date to the plural piezoelectric elements. Ink is ejected from the plural ink ejection nozzles 23 and adhered to the printing medium P.

When the above-mentioned print control process is ended, the print process instructing section 55 ends the first printing scan operation. The process judgment section 51 judges that non-printed data remains (Yes in step ST1 of FIG. 4) and checks that no request for the exceptional discharge process due to the mismatch in paper size is given (No in step ST2). Thereafter, the process judgment section 51 successively reads the data of the first printing medium out of the continuous-printing print data. The process judgment section 51 reads the first paper feeding distance data out of the print data of the first printing medium and instructs the paper feeding process instructing section 53 to perform its process (step ST4).

The paper feeding process instructing section 53 instructed to perform its process executes the flow of the paper feeding process shown in FIGS. 6 and 7. The paper feeding process instructing section 53 first checks whether the PE sensor 36 detects the trailing end edge of the fed printing medium P under print (step ST41). It is assumed that this paper feeding process is the first feeding process for the printing medium P. Accordingly, the paper feeding process instructing section 53 judges No in step ST41. The paper feeding process instructing section 53 performs the sub flow of the paper feeding process of FIG. 7 (step ST42).

In the sub flow of the paper feeding process shown in FIG. 7, the paper feeding process instructing section 53 judges whether this paper feeding process is in the continuous print mode and a next page remains, on the basis of the continuous-printing print data (step ST51). For example, when the next page existence data is included in the print data by printing medium, the paper feeding process instructing section 53 judges that this paper feeding process is in the continuous print mode and a next page remains. It is assumed that this paper feeding process is for the first printing medium P in the continuous print mode. Accordingly, the paper feeding process instructing section 53 judges Yes in step ST51.

The paper feeding process instructing section 53 then judges whether the current position of the trailing end edge of the printing medium P under print passes the inter-page control start position (step ST52). The paper feeding process instructing section 53 specifies the length in the transport direction of the printing mediums F on the basis of the paper size data included in the print data by printing medium, and compares the specified length with the distance (hereinafter, referred to as a feed ending distance) from the inter-page control start position to the leading end edge of the printing medium P under print, which is calculated on the basis of the after-PE-detection PF transport distance 65 or the after-PE-detection ASF transport distance 66. For example, when the feed ending distance is greater, the paper feeding process instructing section 53 can judge that the current position of the trailing end edge of the printing medium P under print has passed the inter-page control start position. This paper feeding process is the first paper feeding process of the printing medium P and the printing medium P under print exists at the inter-page control start position. Accordingly, the paper feeding process instructing section 53 judges No (not pass) in step ST52.

The paper feeding process instructing section 53 judges whether the trailing end edge of the printing medium P under print passes the inter-page control start position as a result of this paper feeding process (step ST53). The paper feeding process instructing section 53 specifies the length in the transport direction of the printing medium P on the basis of the paper size data included in the print data by printing medium and compares the specified length with the value obtained by adding this instructed paper feeding distance to the calculated feed ending distance. For example, when the value obtained by adding this instructed paper feeding distance to the feed ending distance is greater, the paper feeding process instructing section 53 can judge that the position of the trailing end edge of the printing medium P under print has passed the inter-page control start position. This paper feeding process is the first paper feeding process of the printing mediums P. Accordingly, the paper feeding process instructing section 53 usually judges No in step ST53.

When judging No in step ST53, the paper feeding process instructing section 53 sets as a new target PF transport distance (number of pulses) a difference between a value, which is obtained by adding this newly instructed paper feeding distance to the cumulative value of the target PF transport distance instructed to the PF control executing section 41 after the feed process is ended, and the absolute PF transport distance 62 (actual transport distance based on the previous instruction) after the feed process is ended and calculates a new target ASF transport distance (number of pulses) additionally including a correction value (step ST54). Specifically, the paper feeding process instructing section 53 calculates the new target ASF transport distance including the correction value by the use of Expression 1. The new target ASF transport distance including the correction value is slightly larger than the new target PF transport distance.

In Expression 1, “1.05” is a target transport distance correction ratio coefficient representing am extra transport by 5%. The target transport distance correction ratio coefficient may be larger than 1 and equal to or smaller than, for example, 1.05. When the coefficient is 1 or less, the effect of correction is not sufficient and when the coefficient is larger than 1.05, the warp of the printing medium P going into the PD roller 11 increases and the transport distance of the printing medium P does not suitably follow the transport distance of the PF roller 14.
Target ASF transport distance (number of pulses) target PF transport distance (number of pulses)×1.05 Expression 1

When the resolution of the transport distance of the PF rotary encoder 34 is different from the resolution of the transport distance of the ASF rotary encoder 35, a correction coefficient of the resolution based on the ratio of the number of detection pulses of the PF rotary encoder 34 and the number of detection pulses of the ASF rotary encoder 35 in a predetermined transport distance is multiplied by the target ASF transport distance calculated from Expression 1 and the calculation result is set as the new target ASF transport distance (number of pulses) instructed to the ASF control executing section 42.

After calculating the target PV transport distance (number of pulses) and the target ASF transport distance (number of pulses), the paper feeding process instructing section 53 executes a synchronization (tracing) control based on the instructed feeding distance (that is, the target PF transport distance and the target ASF transport distance) (step ST55).

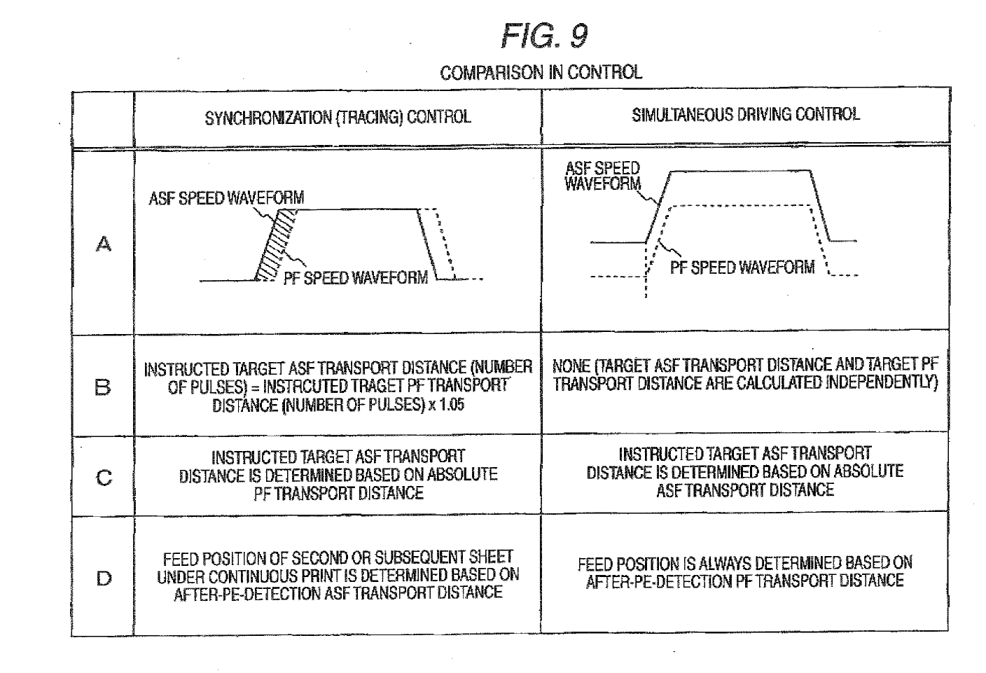

FIG. 9 is a diagram illustrating a comparison table of features of the synchronization (tracing) control and features of the simultaneous driving control in the ink jet printer 1 shown in FIG. 1. The left side of FIG. 9 shows a list of features of the synchronization (tracing) control and the right side of FIG. 9 shows a list of features of the simultaneous driving control. The features are described below.

First, in the synchronization (tracing) controls the PF motor 31 and the ASF motor 32 are simultaneously driven, similarly to the simultaneous driving control as shown in Column A of FIG. 9. Specifically, in the synchronization (tracing) control, the actuation of the ASF motor 32 is started earlier than the actuation of the PF motor 31. In the simultaneous driving control, the actuations of the motors are not limited and both motors are simultaneously actuated.

Second, as shown in Column B of FIG. 9, in the synchronization (tracing) control, the target ASF transport distance (number of pulses) is set slightly larger than the target PF transport distance (number of pulses) by the use of the calculation of Expression 1. In the simultaneous driving control, such a correction of transport distance is not performed. The target PF transport distance (number of pulses) and the target ASF transport distance (number of pulses) are independently calculated.

Third, as shown in Column C of FIG. 9, in the synchronization (tracing) control, the target ASF transport distance instructed to the ASF control executing section 42 is based on the target PF transport distance instructed to the PF control executing section 41 as can be seen from Expression 1. On the contrary, in the simultaneous driving control, the target ASF transport distance instructed to the ASH control executing section 42 is a difference between a value, which is obtained by adding this newly instructed paper feeding distance to the cumulative value of the target ASF transport distance instructed to the ASF control executing section 42 after the teed process is ended, and the absolute ASF transport distance 64 after the feed process is ended (actual transport distance based on the previous instruction). That is, the absolute ASF transport distance 64 serves as a reference. The target PF transport distance instructed to the PF control executing section 41 is a difference between a value, which is obtained by adding this newly instructed paper feeding distance to the cumulative value of the target PF transport distance instructed to the PF control executing section 41 after the feed process is ended, and the absolute PF transport distance after the feed process is ended (actual transport distance based on the previous instruction).

Fourth, in the synchronization (tracing) control, as shown in column D of FIG. 9, the feed position of the second or subsequent printing mediums under continuous print is determined so that the after-PE-detection ASF transport distance 66 after the PE sensor 36 detects the printing medium is equal to the transport distance corresponding to the distance from the E sensor 36 to the print start position. In the simultaneous driving control, the feed position is determined so that the after PE-detection PF transport distance 65 after the PE sensor 36 detects the printing medium is equal to the transport distance corresponding to the distance from the PE sensor 36 to the print start position.

The synchronization (tracing) control has the above-mentioned features in comparison with the simultaneous driving control.

The paper feeding process instructing section 53 instructs the target PF transport distance to the PF control executing section 41 and instructs the target ASF transport distance to the ASF control executing section 42 in the synchronization (tracing) control (step ST55) based on an instructed feeding distance.

In the synchronization (tracing) control, first, the ASF control executing section 42 starts actuating the ASF motor 32. Accordingly, the printing medium P nipped between the LD roller 11 and the LD follower roller 12 is transported. At this time, the printing medium P is loosened between the LD roller 11 and the PF roller 14.

When the value of the absolute ASF transport distance 64 varies by a predetermined amount, the PF control executing section 41 starts actuating the PF motor 31. Accordingly, the printing medium P nipped between the PF roller 14 and the PF follower roller 15 starts its transport. The printing medium P is transported in a state where the printing medium is loosened between the LD roller 11 and the PF roller 14.

The ASF control executing section 42 stops the ASF motor 32 so that the variation of the absolute ASF transport distance 64 after starting the paper feeding process is equal to the target ASF transport distance. The PF control executing section 41 starting its drive later stop 5 the PF motor 31 so that the variation of the absolute PF transport distance 62 after starting the paper feeding process is equal to the target PF transport distance. The transport distance of the printing medium P transported downstream in the transport direction of the printing medium P from the PF roller 14 is the transport distance (number of pulses) of the PF roller 14 and is the instructed target PF transport distance.

The ASE motor 32 starts its actuation earlier than the PF motor 31. However, the target ASF transport distance of the LD roller 11 is substantially equal to the target PF transport distance of the PF roller 14. Accordingly, in the state where the ASF motor 32 and the PF motor 31 are stopped, the looseness between the LD roller 11 and the PF roller 14 is substantially removed.

The target ASE transport distance of the LD roller 11 is slightly greater than the target PF transport distance of the PF roller 14. Accordingly, the stopped LD roller 11 does not hinder the PF motor 31 transporting the printing medium P. The printing medium P does not expanded and drawn between the LD roller 11 and the PF roller 14 by means of the rotation of the PF roller 14 after the ASF motor 32 is stopped. As a result, the actual transport distance of the printing medium P on the downstream side from the PF roller 14 suitably follows the target PF transport distance of the PF roller 14 and is equal to the instructed paper feeding distance with high precision.

In this way, the first paper feeding process of the paper feeding process instructing section 53 which is shown in step ST42 of FIG. 6 is ended. The paper feeding process instructing section 53 checks whether the PE sensor 36 detects the trailing end edge of the printing medium P under print in this paper feeding control (step ST43). In the first paper feeding process, the trailing end edge of the printing medium P is not generally detected. The paper feeding process instructing section 53 judge No in step ST43 and ends the paper feeding process.

In the print data by printing medium, the ink eject ion pattern data and the paper feeding distance data are alternately arranged as shown in FIG. 3. The print process instructing section 55 and the paper feeding process instructing section 53 are alternately selected in accordance with the arrangement order of the ink ejection pattern data and the paper feeding distance data. Accordingly, the printing operation based on the print data is performed on the printing medium P, for example, every scanning width.

As described above, when the printing operation on the first printing medium P is performed and the trailing end edge of the first printing medium P goes out of between the LD roller 11 and the LD follower roller 12, the second printing medium P which is the uppermost printing medium on the rear feed tray 2 pushed up by the hopper 13 is fed with the rotation of the LD roller 11 and is nipped between the LD roller 11 and the LD follower roller 12. In the paper feeding control, the second printing medium P starts its transport with the rotations of the PF motor 31 and the LD roller 11 controlled in the synchronization (tracing) control manner, subsequently to the first printing medium P. The second printing medium P usually starts its transport without any gap from the first printing medium P.

In the paper feeding process on the first printing medium the paper feeding process instructing section 53 switches the instructions of the paper feeding process depending on the position of the trailing end edge of the first printing medium P under print. Specifically, the paper feeding process instructing section 53 switches the instructions of the paper feeding process depending on the following patterns. The paper feeding process in the patterns will be described with reference to FIGS. 2 and 7.

First, right after the first printing medium P starts its transport, the paper feeding process instructing section 53 judges No in step ST53 when the trailing end edge of the printing medium P under print does not pass the inter-page control start position (when it is in area A of FIG. 2) and is expected not to pass the inter-page control start position at the time of ending this paper feeding process (when it is in area A of FIG. 2). The paper feeding process instructing section 53 sets as a new target PF transport distance (number of pulses) a difference between a value, which is obtained by adding this newly instructed paper feeding distance to the cumulative value of the target PF transport distance instructed to the PF control executing section 41 after the feed process is ended, and the absolute PF transport distance 62 after the teed process is ended (actual transport distance based on the previous instruction), calculates the target ASE transport distance of the LD roller 11 slightly larger than the new target PF transport distance by the use of Expression 1 (step ST54), and executes the synchronization (tracing) control (step ST55).

Second, at the time of ending this paper feeding process, the paper feeding process instructing section 53 judges Yes in step ST53 when the trailing end edge of the printing medium P under print is expected to pass the inter-page control start position (when it moves from area A to area B in FIG. 2). The paper feeding process instructing section 53 sets as a new target PF transport distance (number of pulses) a difference between a value, which is obtained by adding the transport distance to the inter-page control start position to the cumulative value of the target PF transport distance instructed to the PF control executing section 41 after the feed process is ended, and the absolute PF transport distance 62 after the feed process is ended (actual transport distance based on the previous instruction), calculates the target ASF transport distance of the LD roller 11 slightly larger than the new target PF transport distance by the use of Expression 1 (step ST56), and executes the synchronization (tracing) control (step ST57). The subsequent printing medium P starting its transport without any gap from the printing medium under print is transported to the inter-page control start position.

Thereafter, the paper feeding process instructing section 53 sets a new target PF transport distance (number of pulses) of the PF roller 14 a difference between a value, which is obtained by adding the remaining portion of the newly instructed paper feeding distance to the cumulative value of the target PT transport distance (which includes the previous transport distance to the inter-page control start position) instructed to the PF control executing section 41 after the feed process is ended, and the absolute PF transport distance after the feed process is ended (the variation based on the previous control to the inter-page control start position) and then supplies the new target PF transport distance to the Fr control executing section 41 (step ST58). Accordingly, the printing medium P is transported by only the PF roller 14. The printing medium under print is transported by this newly instructed paper feeding distance.

Third, when the current position of the trailing end edge of the printing medium P under print has passed the inter-page control start position, the paper feeding process instructing section 53 judges Yes in step ST52. Then, the paper feeding process instructing section 53 sets as a new target PF transport distance (number of pulses) a difference between a value, which is obtained by adding this newly instructed paper feeding distance to the cumulative value of the target VF transport distance instructed to the PF control executing section 41 after the feed process is ended, and the absolute PF transport distance after the feed process is ended (actual transport distance based on the previous instructions) and then supplies the new target PF transport distance to the PF control executing section 41 (step ST59). Accordingly, the printing medium P is transported by only the PF roller 14. The printing medium under print is transported by the newly instructed paper feeding distance.

The paper feeding process instructing section 53 has a fourth pattern. The fourth pattern is selected, for example, in the paper feeding process of the final printing medium P in the continuous print mode. In the fourth pattern, the paper feeding process instructing section 53 sets as a new target PF transport distance (number of pulses) a difference between a value, which is obtained by adding this newly instructed paper feeding distance to the cumulative value of the target PF transport distance instructed to the PF control executing section 41 after the feed process is ended, and the absolute PF transport distance after the feed process is ended (actual transport distance based on the previous instructions) and supplies the new target PF transport distance to the PF control executing section 41 (step ST137). Accordingly, the printing medium P is transported by only the PF roller 14. The printing medium under print is transported by the newly instructed paper feeding distance. In the fourth pattern, the hopper 13 goes down from the feed position to a retreating position and the LD follower roller 12 is in a retreating state where it is separated from the LD roller 11.

When the trailing end edge of the printing medium F under print passes the PE sensor 36 by means of the paper feeding controls, the paper feeding process instructing section 53 judges in step ST43 of FIG. 6 that the PE sensor 36 detects the trailing end edge of the printing medium P under print in the course of transporting the printing medium. The paper feeding process instructing section 53 performs a paper size judgment process (step ST44).

In the paper size judgment process, the paper feeding process instructing section 53 sets an estimated non-printing area width. The estimated non-printing area width corresponds to the length in the transport direction of a portion of the printing medium, which is not subjected to a printing operation in the trailing end of the printing medium P under print. As shown in FIG. 2, the carriage 21 scans a constant position in the printing medium transport path. Accordingly, in the ink jet printer 1, the distance from the PE sensor 36 to the printing area is known in advance. The paper feeding process instructing section 53 basically sets as the estimated non-printing area width a value obtained by adding the width of the printing area (the width in the transport direction of the printing medium) to the distance from the PE sensor 36 to the printing area. In case of a printing operation with no margin, the paper feeding process instructing section 53 sets as the estimated non-printing area width a value obtained by adding a predetermined value to the above-mentioned added value.

When the leading end edge of the subsequent printing medium P passes the PE sensor 36 by means of the paper feeding controls, the detection value calculator 43 updates the after-PE-detection PF transport distance 65 and the after-PE-detection ASF transport distance 66 stored in the memory 39 to the transport distance after a new sheet of paper is detected by the PE sensor 36.

As described above, the paper feeding process and the print process on the first printing medium P are repeated while the instruction patterns in the paper feeding process of the paper feeding process instructing section 53 are switched. When the trailing end edge of the printing medium P under print is detected by the PE sensor 36 in the course of transporting the printing medium, the paper feeding process instructing section 53 judges Yes in step ST41.

The paper feeding process instructing section 5S judges that this instructed feeding distance is greater than the remaining length of the estimated non-printing area width. The remaining length of the estimated non-printing area width is reduced every when the printing operation is performed by the print process instructing section 55. The remaining length of the estimated non-printing area width is reduced, for example, by the width of the printing area every printing, Right after the estimated non-printing area width is set in step ST44, the remaining length of the estimated non-printing area width is greater than this instructed feeding distance. The paper feeding process instructing section 53 judges No in step ST45.

As described above, the estimated non-printing area width is set to a value suitable for the print mode such as a no-margin print mode. Accordingly, when the print process is normally performed, it is not general that this instructed feeding distance is greater than the remaining length of the estimated non-printing area width. However, when this instructed feeding distance is greater than the remaining length of the estimated non-printing area width, the paper feeding process instructing section 53 judges Yes in step ST45 and requests for an exceptional discharge process (step ST48). Details thereof will be described later.

When judging No in step ST45, the paper feeding process instructing section 53 performs a mask setting operation on the print data (step ST46). For example, the print data includes a range greater than the actual paper size. In this case, when the print data is used for the printing operation to the final, the ink may be ejected outside the area of the printing medium P. The ink ejected outside the printing medium P contaminates the inside of the ink jet printer 1. The mask setting operation on the print data is a setting operation for not ejecting the ink in such a manner or for suppressing the ink from being ejected in such a manner to the minimum.

When the mask setting operation on the print data is ended, the paper feeding process instructing section 53 performs the paper feeding process. The paper feeding process instructing section 53 performs the paper feeding process to correspond to one of three patterns shown in FIG. 7, depending on the position in the transport path of the printing medium under print (step ST47). When the paper feeding process is performed, the paper feeding process instructing section 53 ends the paper feeding process.

When the print data are processed, the process judgment section 51 reads the first page identification data for distinguishing the second paper from the first paper in step ST1 of FIG. 4. The process judgment section 51 instructs the discharge process instructing section 54 to perform its process.

The discharge process instructing section 54 instructed to perform its process executes the flow of the discharge process shown in FIG. 8. The discharge process instructing section 54 first judges whether this discharge process is a discharge process in the continuous print mode and whether a next page to be printed exists (step ST71). For example, when the next page existence data is included in the print data by printing medium the discharge process instructing section 54 can judge that this discharge process is in the continuous print mode and a next page exists. The discharge process instructing section 54 may perform the judgment with reference to a flag of a value of which can be rewritten on the basis of the next page existence data or the next page non-existence data read from the print data by the process judgment section 51. This discharge process is a discharge process on the first printing medium P in the continuous printing operation. Accordingly, the discharge process instructing section 54 judges Yes in step ST71.

The discharge process instructing section 54 judges whether the current position of the trailing end edge of the printing medium P under print has passed the inter-page control start position (step ST72). The discharge process instruction section 54 specifies the length in the transport direction of the printing medium P on the basis of the paper size data included in the print data by printing medium and compares the specified length with the feed ending distance. The discharge process instructing section 54 can judge that the current position of the trailing end edge of the printing medium P under print has passed the inter-page control start position, for example, when the feed ending distance is greater.

For example, when the printing operation on the first printing medium P is ended in the halfway of the printing medium, the current position of the trailing end edge of the printing medium P under print does not pass the inter-page control start position. In this case, the discharge process instructing section 54 judges No in step ST72.

When judging that the current position of the trailing end edge of the printing medium P under print does not pass the inter-page control start position, the discharge process instructing section 54 sets the remaining distance to the inter-page control start position as the target PF transport distance (number of pulses) of PF roller 14 so that the trailing end edge of the printing medium P under print is located at the inter-page control start position, calculates the target ASF transport distance (number of pulses) of the LD roller 11 slightly greater than the target PF transport distance, and executes the synchronization (tracing) control (step ST73). Accordingly, the trailing end edge of the printing medium P under print is located at the inter-page control start position. The leading end edge of the next printing medium P starting its transport subsequently to the printing medium P under print also reaches the inter-page control start position.

For example, when the printing operation on the first printing medium P is performed up to the trailing and edge of the printing medium PF the trailing end edge of the printing medium P under print has already passed the inter-page control start position. In this case, the discharge process instructing section 54 judges Yes in step ST72. The discharge process instructing section 54 ends the discharge process without executing a specific transport control.

In this way, when the discharge process of the discharge process instructing section 54 on the first printing medium P is ended, the process on the print data of the first printing medium is ended. When the print process is normally performed such as when the printing medium P has a size matched with the print data is being transported, the leading end edge of the second printing medium P is located at the inter-page control start position at the time of ending the discharge control on the first printing medium P. The process judgment section 51 reads the print data of the second printing medium in step ST4 of FIG. 4 and instructs the feed process instructing section 52 to perform the feed process on the second printing medium P.

The feed process instructing section 52 starts the feed process on the second printing medium in accordance with the flowchart shown in FIG. 5. The feed process instructing section 52 resets the absolute PF transport distance 62 and the absolute ASF transport distance 64 stored in the memory 39 of the ASIC 37 to “0” (step ST11) and then checks the LD nip state. When this feed process is for the second or subsequent printing medium in the continuous print mode, the LD nip state is maintained. Accordingly, the feed process instructing section 52 judges Yes in step ST12.

When the LD nip state is maintained, that is, when judging that this feed process is for the printing operation on the second or subsequent printing medium in the continuous print mode, the feed process instructing section 52 judges whether the inter-page control of setting a gap between plural printing mediums P which are continuously fed has been ended (step ST21). The feed process instructing section 52 specifies the length in the transport direction of the printing medium P on the basis of the paper size data included in the print data by printing mediums and compares the feed ending distance calculated from the absolute PF transport distance 62 or the absolute ASF transport distance before the reset with a value which is obtained by adding distance D indicated by the distance data 71 to the specified length. The feed process instructing section 52 can judge that the inter-page control is ended, for example, when the feed ending distance before the reset is greater.

Referring to a flag which goes upright when the paper feeding process instructing section 53 executes the PF control of step ST58 or ST59 or when the paper feeding process instructing section 53 generates a gap greater than the inter-page gap length between the previous printing medium P and the current printing medium 2, the feed process instructing section 52 may judge that the inter-page control is ended when the flag is upright.

When the inter-page control is not ended such as when the discharge control is executed so that the trailing end edge of the first printing medium P is located at the inter-page control start position, the feed process instructing section 52 executes the inter-page control (step ST22). Specifically, the feed process instructing section 52 sets the remaining distance of the inter-page gap length as the target PF transport distance of the PF roller 14 and instructs the target PF speed to only the PF control executing section 41. Accordingly, the printing medium P is transported by only the PF roller 14. A predetermined gap length is secured between the trailing end edge of the first printing medium P and the leading end edge of the second printing medium P by means of the inter-page control. The gap between the trailing end edge of the first printing medium P and the leading end edge of the second printing medium P is equal to or greater than the predetermined inter-page gap length. The feed process instructing section 52 may set the inter-page gap length as the target PF transport distance of the PF roller 14 and may instruct the target PF speed to only the PF control executing section 41.

In this way, after the inter-page control is executed in step ST22 or when the inter-page control is already ended, the feed process instructing section 52 instructs the feed control including the synchronization (tracing) control up to the print start position to the PF control executing section 41 and the ASF control executing section 42 (step ST23).

In the synchronization (tracing) control on the second or subsequent printing mediums under the continuous print up to the print start position, the ASP control executing section 42 stops the actuation of the ASF motor 32 so that the after PE-detection ASF transport distance 66 corresponds to the distance from the PE sensor 36 to the print start position. As described as the fourth feature in FIG. 9, the PF control executing section 41 stops the actuation of the PF motor 31 so as to stop when the after-PE-detection ASF transport distance 66 corresponds to the distance from the PE sensor 36 to the print start position.

The PF roller 14 starts its rotation later than the LD roller 11. In step ST23, the transport distances of the absolute PF transport distance 62 and the after-PE-detection PF transport distance 65 are smaller than those of the absolute ASF transport distance 63 and the after-PE-detection ASF transport distance 66 by the delay time, that is, by the hatched portion in FIG. 9A As a result, by allowing the PF control executing section 41 to control the PF motor 11 so as to stop when the after-PE-detection PF transport distance 65 reaches the distance from the PE sensor 36 to the print start position, the precision in feed position of the second or subsequent printing mediums is a deteriorated when the plural printing mediums P are continuously fed. Specifically, the feed position of the second or subsequent printing mediums tends to depart upstream in the transport direction 4 of the printing medium P from the feed position of the first printing medium. That is, the second or subsequent printing mediums P under the continuous print tend to depart upstream in the transport direction 4 from the accurate feed position of the first printing medium. As a result, the leading end edge of the printing medium P is fed only to the position in right front of the print start position.

On the contrary, when the PF control executing section 41 controls the PF motor 31 to stop when the after-PE-detection ASF transport distance 66 corresponds to the distance from the PE sensor 36 to the print start position, the leading end edge of the printing medium P is fed to the print start position with high precision. The feed position of the second or subsequent printing medium P is substantially matched with the feed position of the first printing medium P.

Actually, the PF control executing section 41 starts at the same time as the ASF control executing section 42 starts the deceleration and stop control. Right before starting the deceleration and stop control, the ASF detection speed 63 by the LD roller 11 and the PF detection speed 61 by the PF roller 14 are set to a substantially constant speed. Accordingly, by matching the start timing of the deceleration and stop controls with each other, the PF control executing section 41 can stop the PF roller 14 when the ASF control executing section 42 stops the LD roller 11. The PF control executing section 41 can control the PF roller 14 to stop when the transport distance of the LD roller 11 after the PE sensor 36 detects a new printing medium P subsequently fed is a predetermined transport distance.

After feeding the second printing medium P to the print start position, the feed process instructing section 52 judges whether a next page to be printed exists on the basis of the continuous-printing print data or the like (step ST24). For example, when the third or subsequent page does not exist, the feed process instructing section 52 supplies the ASIC 37 with an instruction for actuating the ASF sub motor 33 (step ST25). The ASIC 37 actuates the ASF sub motor 33 and the LD follower roller 12 is separated from the LD roller 11. On the contrary, when the third or subsequent page to be printed exists, the feed process instructing section 52 ends the feed process without separating the LD follower roller 12 from the LD roller 11.

When the second printing medium P starts its transport by the paper feeding process on the first printing medium P or when the second printing medium P starts its transport by the feed process on the second printing medium, the second printing medium P is fed to the print start position by the above-mentioned feed process on the second printing medium P.

Thereafter, in the ink jet printer 1, the print control of the print process instructing section 55 and the paper feeding control of the paper feeding process instructing section 53 are repeated on the basis of the print data of the second printing medium. With the advancement of the print process, the paper feeding process instructing section 53 sets the estimated non-printing area width on the basis of the flowchart shown in FIG. 6 (step ST44), judges whether the instructed feeding distance of each paper feeding process is greater than the remaining length of the estimated non-printing area width (ST45), and performs the mask setting operation on the print data (step 46). When the process judgment section 51 reads final page identification data of the print data of the second printing medium, the discharge process of the discharge process instructing section 54 is started.

The ink jet printer 1 reads the print data by printing medium included in the continuous-printing print data and executes the same controls as the second printing medium on the third or subsequent printing mediums. When the process judgment section 51 reads the print data of the final printing medium under the continuous print in step ST4 of FIG. 4, a is control different from that up to that time is executed.

Specifically, since a next page to be printed does not exist in the paper feeding process on the final printing medium P, the feed process instructing section 52 judges No (final page) in step ST24 of FIG. 5. The feed process instructing section 52 judges No (final page), for example, on the basis of the next page non-existence data in the print setting data. The paper feeding process instructing section 53 gives to the ASIC 37 an instruction for actuating the ASF sub motor 33 (step ST25). The ASIC 37 actuates the ASF sub motor 33 and the LD follower roller 12 is separated from the LD roller 11.

The paper feeding process instructing section 53 judges No in step ST51 of FIG. 7, because a next page to be printed does not exist. The paper feeding process instructing section 53 controls the paper feed in accordance with the fourth pattern of the paper feeding control. That is, the paper feeding process instructing section 53 sets as a new PF target transport distance (number of pulses) a difference between a value, which is obtained by adding this newly instructed paper feeding distance to the cumulative value of the target PF transport distance instructed to the PF control executing section 41 after the feed process is ended, and the absolute PF transport distance 62 after the feed process is ended (actual transport distance based on the previous instruction) and instructs the target PF speed to only the PF control executing section 41 (step ST60). Accordingly, the printing medium P is transported by only the PF roller 14. The pressing contact state of the LD follower roller 12 with the LD roller 11 is released and the printing medium P is transported with the rotation of the PF roller 14.

The discharge process instructing section 54 judges No (final page) in step ST71 of FIG. 8 with reference to the above-mentioned flag, because a next page to be printed does not exist. The paper feeding process instructing section 53 checks that the LD follower roller 12 is in the nip state where it is in contact with the LD roller (step ST74), sets as the target PF transport distance (number of pulses) of the PF roller 14 a predetermined transport distance by which the printing medium P under feed can be transported to the discharge tray, and instructs the target PF speed to only the PF control executing section 41 (step ST75). The pressing contact state of the LD follower roller 12 with the LD roller 11 is released, and the printing medium P having been completely subjected to the printing operation is transported by only the PF roller 14 and discharged to the discharge tray.

In this way, when the print data of the final page among the continuous-printing print data is supplied to the ink jet printer 1, a control different from the control on the printing mediums P under the continuous print is executed. That is, the ink jet printer 1 executes substantially the same control as the paper feeding control in a usual print mode based on the usual print data.

The ink jet printer 1 can perform a printing operation on various printing mediums P such as sheets of regular paper and sheets of photo paper. The ink jet printer 1 can perform a printing operation on the printing medium P with different resolutions. The ink jet printer 1 has plural print modes depending on the types of the printing mediums P or the print quality. The print modes include anode for performing a printing operation on a sheet of regular paper and a mode for performing a printing operation on a sheet of photo paper with high quality.

In a mode for performing a printing operation on the sheet of regular paper at a high speed among the plural print modes, the ink jet printer 1 performs the printing operation using the above-mentioned continuous print mode. That is, the ink jet printer 1 actuates both the ASF motor 32 and the PF motor 31 to continuously feed the plural printing mediums P on the rear feed tray 2, with the LD follower roller 12 in contact with the LD roller 11.

In the other print modes, the ink jet printer 1 feeds the printing mediums P sheet by sheet similarly to known ink jet printers, discharges the printing mediums when the printing operation on the printing mediums P is ended, and feeds the next printing medium P on the rear feed tray 2 to the printing area.

Next, when the print data for continuously transporting the plural printing mediums P and performing the printing operation thereon are supplied, the process on the mismatch in paper size will be described with reference to the case where the printing mediums P placed on the rear feed tray 2 is smaller than the paper size specified by the print data.

When the printing mediums actually placed on the rear feed tray 2 is smaller than the paper size specified by the print data, the PE sensor 36 detects the trailing end edge of the printing medium P under print by allowing the paper feeding process instructing section 53 to perform the paper feeding process. The paper feeding process instructing section 53 judges Yes in step ST43 of FIG. 6 and sets the estimated non-printing area width (step ST44).

In the subsequent paper feeding process, the paper feeding process instructing section 53 judges Yes in step ST41 of FIG. 6 every when the paper feeding process is instructed and then judges whether this instructed transport distance is greater than the remaining length of the estimated non-printing area width (step ST45). When the printing mediums P actually placed on the rear feed tray 2 has the same paper size as the paper specified by the print data, the paper feeding process instructing section 53 judges No in step ST 45 and performs the paper feeding process (step ST47) and the like.

However, when the printing medium P actually placed on the rear feed tray 2 has a paper size smaller than the paper size specified by the print data, this instructed transport distance is finally greater than the remaining length of the estimated non-printing area width by repeating the paper feeding process. The paper feeding process instructing section 53 judges Yes in step ST45 and requests for the exceptional discharge process (step ST48). The paper feeding process instructing section 53 ends its process without performing the paper feeding process.

When the exceptional discharge process is requested by the paper feeding process instructing section 53, the process judgment section 51 judges Yes in step ST2 of FIG. 4. The process judgment section 51 having started the process of continuously transporting the plural printing mediums P and performing the printing operation thereon on the basis of the print data sets the next page non-existence (step ST3). The process judgment section 51 starts the process based on the setting of the next page non-existence in the ink jet printer 1, though the final page of the print data is not processed. The process judgment section 51 stops the print process Thereafter, the process judgment section 51 instructs the discharge process instructing section 54 to perform the discharge process (step ST4). The next page non-existence set in the ink jet printer 1 is stared, for example, in the memory 70. Since the ink jet printer 1 is set to the next page non-existence, the discharge process instructing section 54 judges No in step ST71 of FIG. 8. The discharge process instructing section 54 judges whether the LD nip state is maintained. When the plural printing mediums P are continuously transported, the LD follower roller 12 is maintained in the nip state where it is in contact with the LD roller 11. Accordingly, the discharge process instructing section 54 judges Yes in step ST74. The discharge process instructing section 54 executes the synchronization (tracing) control using a predetermined distance in accordance with the judgment result in step ST76 (step ST77) and the feed process instructing section 52 releases the nip state (step ST78). The discharge process instructing section 54 actuates the PF motor 31 and ends the discharge process.

The printing medium P is discharged by the first discharge process after the paper size is detected. The blank printing medium P transported subsequently to the printing medium P under print is interposed between the PF roller 14 and the PT follower roller 15 and then is fed to the printing area.

When the discharge process of the discharge process instructing section 54 is finished after the exceptional discharge process is requested by the paper feeding process instructing section 53, the process judgment section 51 further instructs the feed process instructing section 52 to perform the feed process in step ST4 of FIG. 4.

The feed process instructing section 52 resets the absolute position in step ST11 of FIG. 5 and then judges whether the LD nip state is maintained. The LD flip state is released in the previous process of the discharge process instructing section 54. The feed process instructing section 52 judges No in step ST12.

The feed process instructing section 52 actuates the ASF su motor 32 into the LD nip state (step ST13) and then executes the simultaneous driving control by a predetermined transport distance (step ST14). The paper feeding process instructing section 52 judges whether the detection result of the PE sensor 36 is changed from paper non-existence to paper existence (step ST15).

In addition, when the printing mediums P placed on the rear feed tray 2 has a paper size smaller than the paper size specified by the print data, the printing mediums P having the small size are continuously transported. Accordingly, in the course of the simultaneous driving control in step ST14, the detection result of the PE sensor 36 may not be changed from paper non-existence to paper existence. When the detection result of the E sensor 36 is not changed from paper non-existence to paper existence (No in step ST15), the feed process instructing section 52 stops the PF motor 31 and the ASF motor 32 (step ST31) and releases the LD nip state (step ST32). Thereafter, the feed process instructing section 52 checks again whether the detection result of the PE sensor 36 is changed from paper non-existence to paper existence in the course of the previous interrupt process (step ST33).

When the detection result is not changed from paper non-existence to paper existence in the course of the previous interrupt process, the feed process instructing section 52 judges Yes in step ST33 and performs a blank paper discharge process. Specifically, the feed process instructing section 52 sets the LD nip state, executes the synchronization (tracing) control by a predetermined transport distance, and then releases the LD nip state (step ST34).

After performing the blank paper discharge process, the feed process instructing section 52 judges whether the blank paper discharge process has been performed a predetermined number of times (for example, twice) (step ST55). When the blank paper discharge process is not repeated a predetermined number of times, the feed process instructing section 52 judges whether the detection result of the PE sensor 36 is changed from paper non-existence to paper existence (step ST33). When the detection result of the PE sensor 36 is not changed from paper non-existence to paper existence, the feed process instructing section 52 repeatedly performs the blank paper discharge process (step ST34) and judges whether the blank paper discharge process is performed a predetermined number of times (for example, twice) (Step ST35).

When the blank paper discharge process is repeated the predetermined number of times, the feed process instructing section 52 requests for an error process (step ST36) and ends the feed process. When the error process is requested, the process judgment section 51 instructs an error processor not shown to perform the error process. The error processor displays an error mark on a display panel not shown. The error processor informs a user of the error.

When it is judged in steps ST15 and ST33 that the detection result of the PF sensor 36 is changed from paper non-existence to paper existence, the feed process instructing section 52 checks that this process is not in the continuous print mode (No in step ST16), releases the LD nip state (step ST18), and transports the printing medium P to the print start position under the simultaneous driving control (steps ST19 and ST20). The printing medium P which has passed the PE sensor 36 and which is nipped between the PF roller 14 and the PF follower roller 15 is transported to the print start position.

When it is judged in steps ST15 and ST33 that the detection result of the PE sensor 36 is changed from paper non-existence to paper existence, the PE sensor 36 detects the leading end edge of the blank printing medium P subsequent to the first clank printing medium P. That is, the PE sensor 36 detects the leading end edge of the second blank printing medium P. Accordingly, the second blank printing medium P is transported to the print start position by means of the first feed process after detecting the mismatch in paper size.

When the first feed process after detecting the mismatch in paper size is ended, the process judgment section 51 instructs the discharge process instructing section 54 to perform the second discharge process. The process judgment section 51 may instructs several times of paper feeding process before instructing the discharge process.

The discharge process instructing section 54 instructed to perform the discharge process judges No in step ST71. Since the LD nip state is released in the feed process (step ST18), the discharge process instructing section 54 judges No in step ST74. The discharge process instructing section 54 performs the discharge process of actuating the PF motor 31 (step ST75). The printing medium P which has been transported to the print start position in the state where it is nipped between the PF roller 14 and the PF follower roller 15 is then discharged.

In this way, when the paper feeding process instructing section 53 detects the printing medium P with a paper size smaller than that specified by the print data in the course of performing the control of continuously transporting the plural printing mediums P and performing a printing operation thereon, the discharge process of the discharge process instructing section 54, the feed process of the feed process instructing section 52, and the discharge process of the discharge process instructing section 54 are carried out. The discharge process instructing section 54 releases the LD nip state in the first discharge process. The feed process instructing section 52 performs the feed process of individually transporting the printing mediums P on the basis of the fact that the LD nip state is released. In the feed process of individually transporting the printing mediums PF the feed process is ended in the state where the LD nip state is released. In the second discharge process, the discharge process instructing section 54 performs the discharge process using the PF motor 31 on the basis of the fact that the LD nip state is released.

As a result, when the paper feeding process instructing section 53 detects the printing medium P with a paper size smaller than that specified by the print data in the course of performing the control of continuously transporting the plural printing mediums P and performing a printing operation thereon, at least two printing mediums P are discharged in addition to the printing medium P under print at the time of detecting a mismatch in paper size. The ink jet printer 1 can early stop the print process without waiting until the print process of continuously transporting the plural printing mediums P is finished.

In this embodiment, a controller including the process judgment section 51, the feed process instructing section 52, the paper feeding process instructing section 53, and the discharge process instructing section 54 is embodied by the micro computer 38. When the paper size of the printing medium P transported to the printing area is not matched with that specified by the print data, the controller rotationally drives the LD roller 11 and the PF roller 14 until the leading end edge of the printing medium P is detected by the PE sensor 36, then separates the LD follower roller 12 from the LD roller 11, and then rotationally drives the PF roller 14.

Accordingly, when the mismatch in paper size is detected in the course of continuously transporting the plural printing mediums P, the controller rotationally drives the LD roller 11 and the PF roller 14 together until the leading end edge of the printing medium P (for example, the printing medium P transported subsequently to the printing medium P under print) transported later than the printing medium P under print is detected by the PE sensor 36 between the LD roller and the PF roller 14. Thereafter, the controller rotationally drives the PF roller 14 after the LD follower roller 12 is separated from the LD roller 11. Therefore, when the mismatch in paper size is detected in the course of continuously transporting the plural printing mediums P, the ink jet printer 1 can discharge the printing mediums P so as to leave no printing medium P in the transport path of the printing mediums P. Accordingly, it is possible to properly interrupt the print process.

In this embodiment, the controller judges that the paper size of the printing medium P transported to the printing area is not matched with that specified by the print data, when a printing operation is performed on the range exceeding the estimated non-printing area of the printing medium P under print, which is judged based on the fact that the trailing end edge of the printing medium P under print is detected by the PE sensor 36. Accordingly, when the paper size of the printing medium transported to the printing area is smaller than that specified by the print data, the controller can detect the mismatch in paper size.

In this embodiment, the controller repeatedly executes the Control operation of rotationally driving the LD roller 11 and the PF roller 14 together until the leading end edge of the subsequent printing medium P is detected by the PE sensor 36. Accordingly, even when the leading end edge of the first printing medium P is detected by the PE sensor 36, the controller can end the rotational driving of the LD roller 11 and the PF roller 14. The controller can detect the leading end edge of the printing medium P for a short time by the minimum driving control.

In this embodiment, when the leading end edge of the subsequent printing medium P is not detected by the PE sensor 36 even by repeatedly performing the control operation of rotationally driving the LD roller 11 and the PF roller 14 together a predetermined number of times, the controller performs a predetermined error process. Accordingly, the controller does not endlessly perform the control operation of rotationally driving the LD roller 11 and the PF roller 14 together.

The above-mentioned embodiment is an exemplary embodiment of the invention, but the invention is not limited to the embodiment. The invention can be modified or changed in various forms without departing from the gist of the invention.

In the above-mentioned embodiment, the controller controls the printing medium P to pass the detection position of the PE sensor 36, to be interposed between the PF roller 14 and the PF follower roller 15, and then to be transported again by the use of the PF roller 14, in the driving control operations until the leading end edge of the printing medium P transported later than the printing medium P under print is detected by the PE sensor 36. However, the controller may continuously perform the driving control operation until the leading end edge of the printing medium P subsequently transported is detected by the PE sensor 36, and then may perform a driving control operation of transporting the printing medium P from the detection position of the PE sensor 36 to the nip position of the PF roller 11 after the detection of the leading end edge.

In this embodiment, the controller detects the mismatch in paper size when the paper size of the printing medium P transported to the printing area is smaller than that specified by the print data. However, the controller may detect the mismatch in paper size when the paper size of the printing medium P transported to the printing area is larger than that specified by the print data. The controller judges whether the remaining distance of the estimated non-printing area width is equal to or greater than a predetermined value (for example, 3 mm) at the time of ending the printing operation of each page, and may detect the mismatch in paper size when the remaining distance of the estimated non-printing area width is equal to or greater than the predetermined value.

In the above-mentioned embodiment, the PE sensor 36 serving to detect the printing medium P between the LD roller 11 and the PF roller 14 is an optical sensor that optically detects the printing medium P. In addition, a sensor serving to detect the printing medium P between the LD roller 11 and the PF roller 14 may include a lever lifted and revolved by the printing medium P transported in the rear printing-medium transport path 4 and an optical sensor that optically detects the position of the lever.

In the above-mentioned embodiment, the detection value calculator 43 stores the transport distance after the detection of the PE sensor 36 in the memory 39 as the after-PE-detection PF transport distance 65 and the after-PE-detection ASF transport distance 66. In addition, for example, the detection value calculator 43 may store in the memory 39 the value of the absolute PF transport distance 62 or the absolute ASF transport distance 64 when the PE sensor 36 detects the printing medium P.

In this modified example, the FP control executing section 41 or the ASF control executing section 42 subtracts the value of the measured absolute PF transport distance stored in the memory 39 from the absolute PF transport distance 62 stored in the memory 39 and can use the subtraction result as the after-PE-detection PF transport distance 65. The PF control executing section 41 or the ASF control executing section 42 subtracts the value of the detected absolute ASP transport distance stored in the memory 39 from the absolute ASF transport distance 64 stored in the memory 39 and can use the subtraction result as the after-PE-detection ASF transport distance 66.

In the above-mentioned embodiment, for example, when feeding plural printing mediums P on the rear feed tray 2, the ink jet printer 1 continuously feeds the plural printing mediums P. In addition, for example, when feeding plural printing mediums on the front feed tray 3, the ink jet printer 1 may continuously feed the plural printing mediums P.

In the above-mentioned embodiment, the print data supplied to the ink jet printer 1 is exemplified as being generated from the personal computer which can communicate with the ink jet printer 1. In addition, for example, a digital still camera (DSC) or the like may supply the print data by communicating with the ink jet printer 1. In a so-called multifunction device equipped with the ink jet printer 1, a scanner unit or an IC card reader disposed therein can supply the print data by communicating with the ink jet printer 1.

The invention can be suitably applied to an ink jet printer and the like.

What is claimed is:

1. A method of interrupting a print process in a continuous transport mode, in which a first roller and a second roller that is disposed at a downstream side of the first roller are operable to transport, a plurality of printing mediums including a first medium and a second medium immediately subsequent to the first medium, to a printing area at which a printing operation corresponding to print data is performed to the plurality of printing mediums, and a third roller is operable to transport the plurality of printing mediums together with the first roller with being in contact with the first roller, the method comprising:
detecting the plurality of printing mediums, respectively, between the first roller and the second roller;
driving the first roller and the second roller until a leading end edge of the second medium is detected, when a size of the first medium is different from a size specified by the print data;
separating the third roller from the first roller; and
driving only the second roller to transport the second medium after the third roller is separated from the first roller.

2. The method according to claim 1, wherein
at least a part of the first medium is located in the printing area,
it is judged that the size of the first medium is different from the size specified by the print data, when the printing operation is performed on an area exceeding a non-printing area of the first medium, which is judged based on a fact that a trailing end edge of the first medium is detected.

3. The printer according to claim 1, wherein
in the process of driving the first and second rollers, the first and second rollers driven by a predetermined amount is repeated until the leading end edge of the second medium is detected.

4. The printer according to claim 3, wherein
a predetermined error process is performed when the leading end edge of the second medium is not detected even when the first and second rollers driven by the predetermined amount is repeated a predetermined number of times.

5. A printers including a first roller and a second roller that is disposed at a downstream side of the first roller which are operable to transport, a plurality of printing mediums including a first medium and a second medium immediately subsequent to the first medium, to a printing area at which a printing operation corresponding to print data is performed to the plurality of printing mediums, and a third roller which is operable to transport the plurality of printing mediums together with the first roller with being in contact with the first roller, the printer comprising:
a sensor, operable to detect the plurality of printing mediums, respectively, between the first roller and the second roller; and
a controller, when a size of the first medium is different from a size specified by the print data, operable to drive the first roller and the second roller until a leading end edge of the second medium is detected by the sensor, and operable to drive only the second roller to transport the second medium after separating the third roller from the first roller.
